(19) United States
(12) Patent Application Publication
(10) Pub. No.: US 2022/0172282 A1
(43) Pub. Date: Jun. 2, 2022

(54) Spend-based Discount Rent Pricing System and Methods for Affordable Real Estate Development

(71) Applicant: OX IP, LLC, Santa Rosa Beach, FL (US)

(72) Inventor: Casey Tippens, Santa Rosa Beach, FL (US)

(21) Appl. No.: 17/457,197

(22) Filed: Dec. 1, 2021

Related U.S. Application Data
(60) Provisional application No. 63/199,013, filed on Dec. 1, 2020.

(51) Int. Cl. G06Q 40/02; G06Q 50/16; G06Q 20/10; G06Q 20/36; G06Q 20/40; G06Q 20/34

(52) U.S. Cl. CPC G06Q 40/02; G06Q 50/16; G06Q 20/3437; G06Q 20/3676; G06Q 20/401; G06Q 20/102

(57) ABSTRACT

The present system and methods allow for receiving first customer data, storing the first customer data in one or more databases, automatically determining whether the customer data satisfies a predetermined condition, in response to the customer data satisfying the predetermined condition, converting the customer data to a standardized format based on one or more conversion rates, automatically determining whether the converted customer data in the standardized format satisfies a predetermined criteria, and in response to the converted customer data in the standardized format satisfying the predetermined criteria, sending a notification to a real estate management platform, wherein the notification includes content based on the converted customer data in the standardized format. Via the system and methods, an employee or a commercial property tenant may receive a rent reduction or eligibility for affordable real estate.

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

### CROSS-REFERENCES TO RELATED APPLICATIONS

This application claims priority to U.S. Provisional Patent Application No. 63/199,013, entitled “Spend-based Discount Rent Pricing System and Methods for Affordable Real Estate Development,” filed on Dec. 1, 2020, which is now pending, and which is incorporated by reference in its entirety.

### TECHNICAL FIELD

The present disclosure relates generally to development and investment in low-cost or affordable real estate, and more particularly to systems and methods for transforming how rent is valued and priced so that a more affordable market-rate real estate development is economically viable at an impactful scale.

### BACKGROUND OF THE INVENTION

Cities all over the world are looking for ways to solve the same problem: how to develop economically and still remain affordable for every citizen. The affordability of cities is more than a crisis: it is a symptom of a systemic problem in the way the current real estate market works.

In today's system, market forces dictate property values (and, thus, rent prices), not the cost of the resources used to build them. Because of this, high-opportunity locations quickly become unattainable for most households and small businesses. The unintended consequences of “progress” and market-driven rents is a housing-affordability problem that goes unsolved: small, local businesses are driven out in favor of national, bankable chains, entrepreneurship is stifled, local economies lose their dynamism, local dollars are siphoned out of communities to out-of-town corporate landlords and investors, and gentrification perpetuates and exacerbates inequality that threatens the foundation and fabric of nation and security.

What is needed is a new system that makes a cost-driven market viable.

### BRIEF SUMMARY

This Brief Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

The present disclosure provides value transformation system and methods for affordable real estate development and investment. In some embodiments, the system provides a discount organization, a member account, and a user account. The discount organization is linked to the developer, investor, owner, or landlord. In some embodiments, the member account is linked to an employer, and the user account is linked to an employee. The member account (employer) provides payment to the discount organization (owner) for membership, and the user account (employee) receives benefits from the discount organization based on certain user activity, such as use of payments platform for payment transactions by the employee. In some embodiments, the benefits received by the employee include a rent reduction or eligibility for affordable housing near the place of employment.

In other embodiments, the present invention allows a developer to transform value from high rent payments to other forms of value associated with the user activity. Such alternative forms of value could be value derived from offering banking or financial services to the employee and/or employer via the discount organization in some embodiments.

Another aspect of the disclosure is a system. The system may include a computer-implemented system for spend-based discount rent pricing for affordable real estate development. The system may include one or more databases configured to receive and store one or more customer accounts. Each customer account may include an account identifier, and customer data associated with the account identifier. The customer data may include customer payment data or customer purchase data. The system may include one or more computer-readable storage media having executable instructions store thereon. The system may include one or more computer processors. The one or more processors, in response to executing the executable instructions, may be configured to perform various functions. The functions may include receiving first customer data. The functions may include storing the first customer data in the one or more databases. The customer data associated with the account identifier may include the first customer data. The functions may include automatically determining whether the customer data satisfies a predetermined condition. The functions may include, in response to the customer data satisfying the predetermined condition, converting the customer data to a standardized format based on one or more conversion rates. The functions may include automatically determining whether the converted customer data in the standardized format satisfies a predetermined criteria. The functions may include, in response to the converted customer data in the standardized format satisfying the predetermined criteria, sending a notification to a real estate management platform. The notification may include content based on the converted customer data in the standardized format.

Another aspect of the disclosure is a computer-computer implemented method. The method may include a computer-implemented method for spend-based discount rent pricing for affordable real estate development. The method may include receiving customer data. The method may include storing the customer data in one or more databases. The customer data may be associated with an account identifier stored on the one or more databases. The method may include automatically determining whether the customer data satisfies a predetermined condition. The method may include, in response to the customer data satisfying the predetermined condition, converting the customer data to a standardized format based on one or more conversion rates. The method may include automatically determining whether the converted customer data in the standardized format satisfies a predetermined criteria. The method may include, in response to the converted customer data in the standardized format satisfying the predetermined criteria, sending a notification to a real estate management platform. The notification may include content based on the converted customer data in the standardized format.

Another aspect of the disclosure is another computer-implemented method. The method may include another computer-implemented method for spend-based discount rent pricing for affordable real estate development. The method may include obtaining clearance and settlement data from a first merchant payment platform. The clearance and settlement data may include data electronically captured from a customer payment card. The method may include generating customer payment data based on the clearance and settlement data. The customer payment data may include a payment amount. The method may include, in response to the customer payment data satisfying one or more predetermined conditions, converting the payment amount of the customer payment data to a standardized format based on one or more conversion rates. The method may include combining the converted payment amount with previous converted payment amount data associated with a customer. The method may include, in response to the combined converted payment amount satisfying one or more predetermined criteria, generating a first payment amount adjustment. The method may include applying the first payment amount adjustment to a real estate rent amount associated with the customer.

Numerous other objects, advantages and features of the present disclosure will be readily apparent to those of skill in the art upon a review of the following drawings and description of a preferred embodiment.

### BRIEF DESCRIPTION OF THE DRAWINGS

FIG. 1 is a schematic block diagram illustrating one embodiment of a system for spend-based discount rent pricing and affordable real estate development.

FIG. 2 is a schematic block diagram illustrating one embodiment of a data flow of a system for spend-based discount rent pricing and affordable real estate development.

FIG. 3 is a schematic block diagram illustrating one embodiment of a system for spend-based discount rent pricing and affordable real estate development showing further detail of a banking platform.

FIG. 4 is a schematic block diagram illustrating another embodiment of a system for spend-based discount rent pricing and affordable real estate development showing further detail of a merchant payment platform.

FIG. 5 is a schematic block diagram illustrating one embodiment of a system for spend-based discount rent pricing and affordable real estate development showing further detail of a price adjustment platform.

FIG. 6 is a schematic block diagram illustrating another embodiment of a system for spend-based discount rent pricing and affordable real estate development showing further detail of a real estate platform.

FIG. 7 is a schematic block diagram illustrating one embodiment of a system for spend-based discount rent pricing and affordable real estate development showing further detail of a customer device.

FIG. 8A is a front view illustrating one embodiment of a customer payment card in a system for spend-based discount rent pricing and affordable real estate development.

FIG. 8B is a back view illustrating another embodiment of the customer payment card in a system for spend-based discount rent pricing and affordable real estate development.

FIG. 9A is a flowchart illustrating one embodiment of a computer-implemented method for spend-based discount rent pricing for affordable real estate development.

FIG. 9B is a continuation of the flowchart of FIG. 9A.

FIG. 10A is a flowchart illustrating one embodiment of a computer-implemented method for spend-based discount rent pricing for affordable real estate development.

FIG. 10B is a continuation of the flowchart of FIG. 10A.

### DETAILED DESCRIPTION

While the making and using of various embodiments of the present invention are discussed in detail below, it should be appreciated that the present invention provides many applicable inventive concepts that are embodied in a wide variety of specific contexts. The specific embodiments discussed herein are merely illustrative of specific ways to make and use the invention and do not delimit the scope of the invention. Those of ordinary skill in the art will recognize numerous equivalents to the specific apparatus and methods described herein. Such equivalents are considered to be within the scope of this invention and are covered by the claims.

As used herein, the term “entity” may include a natural person or a business entity unless otherwise noted. A “business entity” may include a sole proprietorship, a partnership, a limited liability company, a corporation, or some other type of business entity. The term “tenant” may include a natural person or a business entity. “Real estate” may include any type of real estate, including residential (including single family housing, multi-family housing, a house, an apartment, a condominium, a timeshare property, a rental property, etc.), commercial, industrial, or undeveloped land.

The term “computing device” may include a web server, an application server, a database server, a desktop computer, a laptop computer, a tablet computer, a smart phone, or some other type of computing device. Furthermore, the term “or” includes “and/or” unless otherwise noted. The term “a” or “an” means “one or more” unless otherwise noted.

The present invention relates to a system and methods for incentivizing development of affordable real estate in high-rent markets by transforming value from rent payments to alternative forms of value, such as value derived from providing financial services to tenants. The present invention provides systems and methods for providing discounts to tenants seeking affordable real estate in high-rent areas by membership in a discount organization. The systems and methods of the present invention utilize a membership-based rewards, or points, system to allow tenants, landlords, and employers to all work together to achieve more affordable real estate options.

In some embodiments, the present invention provides a method of providing affordable housing, including offering rental prices below market rates for a specific area, to a select group of available tenants who are needed for work or other activities in that area (but who would otherwise be unable to pay the market rates in the area). For example, in a first embodiment, an employer in an area with high rent may join as a member of a discount organization. The employer pays a membership price to the discount organization, and the membership price may be based on the number of employees of the employer. Once the employer joins the discount organization, the employees gain access to benefits provided by the discount organization. The discount organization provides memberships to small and medium sized businesses with one to 50 employees in some embodiments. In other embodiments, the discount organization may offer memberships to larger employers.

In one or more embodiments, the present invention provides a method of providing affordable commercial or industrial real estate, including offering rental prices below market rates for a specific area, to a select group of available tenants who would otherwise be unable to pay the market rates in the area. For example, in one embodiment, the owner of a commercial property in an area with high rent may join as a member of a discount organization. The owner pays a membership price to the discount organization, and the membership price may be based on the number of commercial tenants that the owner rents real estate to. Once the owner joins the discount organization, the commercial tenants gain access to benefits provided by the discount organization. The discount organization provides memberships to small and medium sized real estate owners with less than a certain amount of commercial tenants or with tenants whose revenue is under a certain amount in some embodiments. In other embodiments, the discount organization may offer memberships to larger commercial real estate owners. Although the discussion herein, in certain parts, may focus on commercial real estate owners, the same concepts and discussion apply to industrial real estate owners and owners of other types of real estate.

In some embodiments, the benefits offered to the employee by the employer (who is a member of the discount organization) include reduced-rent or affordable housing options at local housing in the same area as the employer. The benefits offered to the employee are highly desirable, because without those benefits, the employee simply wouldn't be able to afford rent near the employer's location. This incentivizes employees to seek employment with employers who belong to the discount organization. By utilizing the reduced-rent benefits offered by the employer (via the employer's membership in the discount organization), the employee is now able to afford nearby housing.

Similarly, in one or more embodiments, the benefits offered to the commercial tenants by the commercial real estate owner (who is a member of the discount organization) include reduced rent or affordable commercial real estate options in an area of high rent where the real estate owner may be attempting to attract certain types of small businesses. The benefits offered to the commercial tenant are highly desirable because without those benefits, the tenant simply wouldn't be able to afford rent in a certain location. This incentivizes commercial tenants to seek locations with real estate owners who belong to the discount organization. By utilizing the reduced-rent benefits offered by the real estate owner (via the owner's membership in the discount organization), the commercial tenant is now able to afford nearby commercial real estate.

In some embodiments, the present invention operates to filter the set of people who are eligible to receive affordable real estate options by only offering discount organization memberships to select employers/real estate owners in the local area (who need employees/commercial tenants) where the affordable real estate is located. By filtering the available set of benefit recipients, the present invention solves a problem of people taking affordable real estate who don't really need it to live/operate in that area (i.e., entities who could otherwise afford to pay market rates in the area).

The reduced rents provided to the eligible employees/commercial tenants are made possible by transforming value from rent payment dollars to another form of value. For example, in some embodiments, an eligible employee/commercial tenant would sign up for a consumer bank account with a payments platform offered by the discount organization. The payments platform may include the use a payment card provided by the discount organization. When the employee/commercial tenant makes purchases on the card, instead of receiving cash back or points as offered by some other payment card companies, the employee/commercial tenant would receive points or credits toward affordable real estate options. Once the employee/commercial tenant makes enough points or credits and achieves status, the employee/commercial tenant is able to receive a rent reduction or affordable real estate benefit. Each time the employee/commercial tenant makes a payment transaction using the card, points may be accumulated that could be applied toward rent discounts or affordable real estate.

The end result is the employee/commercial tenant receives a benefit in the form of a rent reduction that equates to an affordable real estate option near a certain area that otherwise wouldn't be available to that employee/commercial tenant. The discount organization also realizes value associated with offering the financial services and banking account to the employee/commercial tenant. In most cases, the employee/commercial tenant already uses a payment card for payment transactions, but by substituting the conventional payment card with a new payments platform linked to the discount organization and benefit program (offered by the employer/commercial real estate owner via membership in the discount organization), the employee/commercial tenant is now able to realize a new type of value—rent reduction—that otherwise was not available. As the employee's/commercial tenant's status in the benefit program increases through use of the payments platform, or other activities linked to the program, the employee may be eligible for increased rent discounts or other benefits.

The system of the present invention provides substantial network effects in that when more employees/commercial tenants and consumers are using a payments platform linked to the benefit program, more discounts and more affordable real estate options may be provided. Many users are likely to seek banking accounts with the discount organization to build points and status for affordable real estate eligibility. This, in turn, creates more value for the discount organization and investors in the development of the affordable real estate project. Additional activities that may be offered by the discount organization in exchange for points or status include credit card services, digital wallets, wire transfers, currency exchanges, loans, lines of credit, invoicing, payroll processing, etc. Additional external user activities such as merchant purchases by individual users also provide monetized value to the discount organization and allow the individual user to accumulate points and status that may be later exchanged for affordable real estate options.

Another benefit to employees/commercial tenants who participate in the system in some embodiments will be an ability to buy products and services within member spaces and member hubs at discounted prices. In some embodiments, the present invention provides member hubs that offer services such as printing, copying, shipping, office supplies, coffee, food, beverages, basics, etc. Purchases by employees/commercial tenants earn points for status and additional benefits of credits that can be used in member spaces and member hubs. Such credits may be used to pay for renting meeting spaces or other on-demand spaces.

Employees/commercial tenants are incentivized to use the financial services offered by the discount organization to accumulate points and status before needing housing or commercial space. An employee/commercial tenant is thus able to “save” points and status until such time as the affordable rents are actually desired. By saving more points and status, an employee/commercial tenant may be able to plan for a longer desired tenancy at the affordable rates provided via participation in the system. Such accumulation behavior by employees/commercial tenants also benefits the discount organization, investors, and owners because it allows forecasting of future demand, and creates a captive demand for development of affordable real estate as employees/commercial tenants will seek to redeem rent reductions at some point in the future for points earned. The present invention allows accurate forecasting of future affordable real estate demand based on current individual user activity and status tracking.

In some embodiments, employees/commercial tenants are provided lease options according to the status level of the user's wallet. For example, when a user signs up to participate in the system they have a desired rental size in mind. The user will select a space category including a grouping of available units in a specific size range. Different space categories require different wallet sizes, so a user with a smaller wallet size (based on point and status accumulation) would only be able to see a subset of all available space categories. On the other hand, a user with a larger wallet size (based on more points and status) would have access to additional space categories. A business with more revenue or income will be able to earn more points and status, and in turn will be able to access larger space categories. In some embodiments, available space categories will also be filtered based on use characteristics, such as retail, food and beverage, storage, etc.

In the system of the present invention, employers/commercial real estate owners are also incentivized to participate for several reasons. First, employers/commercial real estate owners want to increase the pool of available employees/commercial tenants in a certain area (e.g., for employers, near the place of employment). This increases worker/tenant quality and reduces worker/tenant turnover. Additionally, by joining the discount organization, employers/commercial real estate owners may also receive access to benefit programs offered by the discount organization at the employer/owner level. For example, as the employer/commercial real estate owner opens an account and uses a payments platform to make business purchases, the employer/owner also accumulates points or rewards. The employer/owner may be able to use those points and associated status in the program to realize reduced commercial lease rents from the building landlords, especially in mixed-use developments in urban areas. This also creates more value for the discount organization due to the financial services and banking accounts offered to the member employers/commercial real estate owners. Thus, an employer/owner has significant incentives to be a member of the discount organization.

In the present invention, the discount organization and investors realize value by providing financial services in the form of payments platform accounts for the employees/commercial real estate tenants and the employers/owners. As more users open accounts, the value increases. The discount organization also realizes value from the membership fees paid by the employers/commercial real estate owners. The value realized by the discount organization is thus transformed from what would otherwise be rent payment dollars to other forms of value associated with financial services, bank accounts, and payments platform activities by employees/tenants and employers/commercial real estate owners. The traditional rent dollars could also be transformed to other forms of value through the benefits offered to members and users. The overall outcome of the system is to provide significant affordable rent options for individuals and businesses that wouldn't otherwise be available by transforming value from one form of payment activity to another.

In one exemplary embodiment of the present invention, a developer may seek to build a new building in an urban area at a development cost of $50 million. In order to fund the development, the developer is required to seek funding from third-party sources, such as private equity. When a private equity investor funds development, a return on investment is expected. Thus, under a traditional development model, the developer must set rents at a high, local market price or even higher to provide the desired return to the investor. Otherwise, the investor wouldn't make the investment. This model does not allow for affordable housing, because investors are unwilling to accept lower returns when a market will support higher rates. In this scenario, the building might sell at $75 million at the time of exit to allow the investor to recoup investment costs. However, the present invention transforms the realized $25 million in value from revenue in the form of high rents to other forms of value, such as value derived from providing financial services such as bank accounts linked to payments platforms used by the employees and employers who reside and work in the building. As such, value is still realized by the developer and investors, but the realized value is provided via financial services instead of rent payments, and substantial benefits are also provided to the tenants in the form of reduced rents.

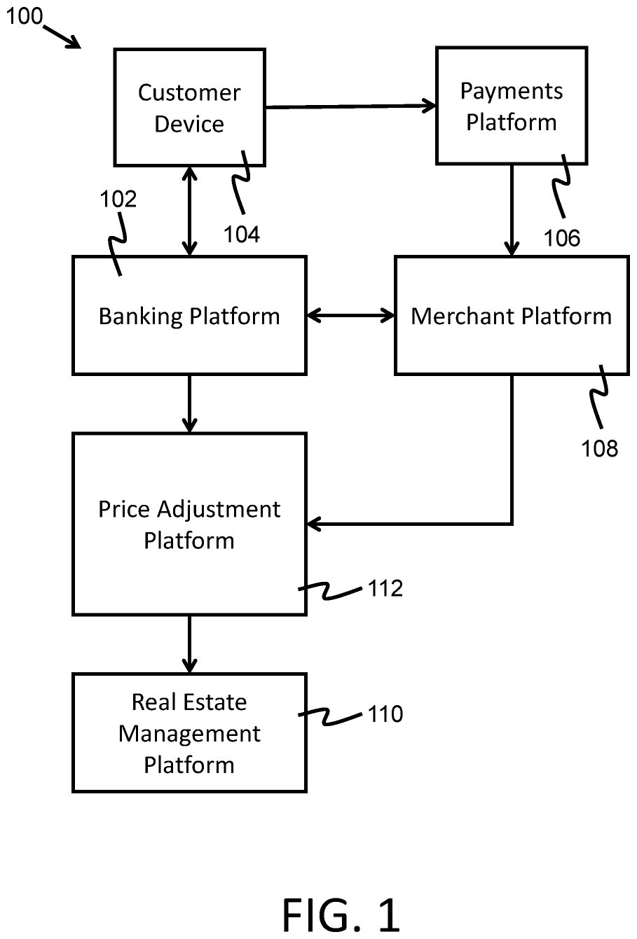

In various embodiments, the alternative forms of value are provided by banking and payment services. FIG. 1 depicts one embodiment of a system 100. The system 100 may include a banking platform 102. The system 100 may include a customer device 104. The system 100 may include a customer payments platform 106. The system 100 may include a merchant platform 108. The system 100 may include a real estate management platform 110. The system 100 may include a price adjustment platform 112. One or more of the components of the system 100 may be in data communication with each other via a data network.

In some embodiments, the banking platform 102 may provide banking services or banking functionality to a customer. The banking platform 102 may be owned, operated, controlled by, or otherwise associated with a discount organization. The discount organization may include one or more members, which may include employers in an area with high rent. The customer that receives banking services or banking functionality from the banking platform 102 may include an employee of the employer.

In one or more embodiments, the customer may user the customer device 104 (e.g., a mobile computing device) to access the banking services or banking functionality. The customer may use the customer device 104 or the customer payments platform 106 to pay for goods or services at a merchant, and the merchant may use the merchant platform 108 to accept the payment. The merchant platform 108 may send data about the customer device's 104 or the payments platform's 106 interaction with the merchant platform 108 (e.g., the amount of money the customer spent at the merchant using the customer device 104 or the payment platform 106) to the banking platform 102 or the price adjustment platform 112. The price adjustment platform 112 may use the data from the merchant platform 108 or the banking platform 102 to automatically determine whether the customer's activity fulfills one or more predetermined conditions. In response to the determining that the customer's activities satisfy predetermined criteria, the price adjustment platform 112 may notify the real estate management platform 110, and the real estate management platform 110 may adjust a rent amount associated with the customer.

Further details and information about one or more embodiments of the disclosure are now discussed. In one embodiment, the system 100 may include a discount organization. The discount organization may include an entity that may provide memberships to other entities, such as employers or businesses. The discount organization may offer one or more benefits to its member entities. Benefits may include reduced-rent or affordable housing options at local housing in the same geographic area as a member entity. Employees of the member entity may gain access to the benefits provided by the discount organization. In some embodiments, the discount organization may filter the set of entities or people who are eligible to receive benefits. For example, the discount organization may only offer benefits to employers whose place(s) of business are located within a certain area, such as a traditionally high-rent area of a city. The discount organization may be linked to a developer, investor, owner, or landlord of real estate property. The discount organization may offer benefits (such as discounted rent) at one or more of the real estate properties associated with a linked developer, investor, owner, or landlord.

In some embodiments, the discount organization may own, operate, control, use or otherwise be associated with a banking entity. The banking entity may own, operate, control, or otherwise use the banking platform 102. The banking platform 102 may provide banking services or functionality. The banking services and functionality may include providing a bank account (e.g., a checking account, a savings account, a money-market account, or another type of financial account), providing a line of credit, or providing access to a payment platform (e.g., the payment platform 106). The banking services and functionality may include charging fees in exchange for providing the banking services and functionality, providing payments to merchants, transferring money between bank accounts, or other functionality.

In some embodiments, the banking entity may include one or more customers. A customer may include a natural person or a business entity. A customer may include an employee of an employer who is a member of the discount organization. A customer may include a commercial real estate tenant of a commercial real estate owner who is a member of the discount organization. A customer may use one or more banking services of the banking entity. The customer may use the customer device 104 to access the banking platform 102 and use at least a portion of the banking services.

The banking platform 102 may include one or more computing devices. The banking entity may use the banking platform 102 to provide the banking services and functionality. For example, the banking platform 102 may track balances in a customer's bank account or line of credit. The banking platform 102 may coordinate sending payment to merchants that accept payments from the payments platform 106 provided by or managed by the discount organization. The banking platform 102 may allow customers of the banking entity to view the customer's banking information via a mobile application or web interface.

In one embodiment, the banking platform 102 may receive one or more fees for providing the banking services. The one or more fees may include a membership fee from a customer or the employer of the customer, who may be a member of the discount organization. The customer or employer may pay the membership fee for being a member of the bank entity that uses the banking platform 102. The one or more fees may include a digital banking services fee. The customer or employer may pay the digital banking services fee for accessing banking functionality of the banking platform 102 via the Internet. In some embodiments, the customer may purchase a product or service from the bank entity that uses the banking platform 102. A product or service of the bank entity may include loans, mortgages, consumer credit reports, certain types of insurance, wealth management, merchant services (e.g., credit card processing, reconciliation, check collecting, direct deposits), or other products and services. The customer or employer may pay for purchasing the product or service.

In one embodiment, a customer may use the customer device 104. The customer device 104 may include a computing device. The customer device 104 may allow a customer to access the banking platform 102 and manage an account the customer may have on the banking platform 102. In one embodiment, the customer device 104 may include a mobile application in data communication with the banking platform 102, or the customer device 104 may access the banking platform 102 via a web browser. In some embodiments, the customer may user the customer 104 device to view a balance in an account or a line of credit, transfer money between accounts on the banking platform 102, or otherwise manage functionality of the banking platform 102 associated with the customer. The customer may use a mobile payment or digital wallet functionality of the customer device 104 to make payments. The mobile payment or digital wallet functionality may connect to the banking platform 102.

In one embodiment, the system 100 may include the payments platform 106. The discount organization may own, operate, control, use, or otherwise be associated with the payments platform 106. In some embodiments, the banking entity may own, operate, control, use, or otherwise be associated with the payments platform 106. The payments platform 106 may provide the customer with the ability to pay for goods or services. In some embodiments, the banking entity that uses the banking platform 102 may provide access to the payments platform 106 to the customer. In one embodiment, the discount organization or the banking entity providing access to the payments platform 106 for the customer may include issuing a customer payment card to the customer. The customer payment card may include a debit card, a credit card, an automatic teller machine (ATM) card, or some other type of payment card. The customer may use the customer payment card to purchase goods or services or otherwise make payments. In some embodiments, the customer using the payments platform 106 to pay for goods or services may include the customer using a mobile payment or digital wallet functionality installed on the customer's customer device 104. In one or more embodiments, the customer using the payments platform 106 to pay for goods or services may include the customer entering financial information associated with the customer's user account on the payments platform 106 into a webpage of a merchant entity that offers goods or services. As discussed herein, the customer making a payment using the payments platform 106 may include the customer using a customer payment card, the mobile payment or digital wallet functionality of the customer device 104, an electronic funds transfer (EFT) involving the banking platform 102, a wire transfer using the banking platform 102, or some other type of payment using the banking platform 102.

In some embodiments, a merchant entity may own, operate, control, or otherwise use the merchant platform 108. The merchant entity may include a natural person or a business entity that accepts payment. Although the term “merchant” is used to describe the merchant entity, the merchant entity may include an entity that does not sell goods or services. The merchant entity may include a non-profit organization, a charity organization, a government entity, or some other type of entity that accepts payment.

In one or more embodiments, the merchant platform 108 may include one or more computing devices. The merchant platform 108 may include a point-of-sale (POS) terminal configured to receive payment information from the payments platform 106 (e.g., via the mobile payment/digital wallet of the customer device 104 or the customer payment card). The merchant platform 108 may include an interface that can receive customer payment information. For example, the merchant platform 108 may include a webpage where the customer can enter payment information in order to pay for goods or services. The merchant platform 108 may receive the payment information from the payments platform 106 and use the data to authenticate the payment method or receive payment from the banking platform 102.

In one embodiment, the merchant platform 108 may send data about the customer's interaction with the merchant entity to the banking platform 102 or to the price adjustment platform 112. The data about the customer's interaction with the merchant entity may be called “customer payment data.” In some embodiments, the customer payment data may include the amount of money the customer spent at the merchant. The customer payment data may include the frequency at which the customer pays the merchant entity (e.g., for goods or services, to make a donation, to pay a fee, or to otherwise make payments). The customer payment data may include data about the specific goods or services that the customer purchased from the merchant entity, the specific donations the customer gave to the merchant entity, or the specific fees or payments that the customer made to the merchant entity. The customer payment data may include other data about the customer's payments to the merchant entity.

In some embodiments, a real estate entity may own, operate, control, or otherwise use the real estate management platform 110. The real estate entity may include a developer, investor, owner, or landlord linked to the discount entity. The real estate entity may own, operate, or manage one or more real estate properties. A real estate property may include a residential property, a commercial property, or some other type of property. The real estate entity may include one or more tenants. A tenant may include an entity that may rent one or more properties from the real estate entity. The tenant may pay the real estate entity rent in exchange for occupying the one or more properties.

In one embodiment, the real estate management platform 110 may include one or more computing devices. The real estate management platform 110 may manage the one or more tenants and the one or more real estate properties of the real estate entity. Each real estate property may include a rent amount. The rent amount may include an amount of money that the tenant of the property pays to the real estate entity to occupy the property. The tenant may pay the rent amount daily, weekly, semi-monthly, monthly, quarterly, semi-annually, annually, or at some other frequency. The real estate management platform 110 may include further information about one or more real estate properties, such as location, amenities, size, or other property information. The real estate management platform 110 may include information about the one or more tenants. The tenant information may include one or more real estate properties that a tenant occupies. The tenant information may include biographical information (e.g., name, age, sex, occupation), financial information (e.g., income, bank information), correspondence information (e.g., mailing address, email address, phone number), or other information. The customer information may include at least a portion of the customer payment data discussed above.

A customer of the discount entity may also be a tenant of the real estate management platform 110. In one embodiment, the discount organization may also be the real estate entity that uses the real estate management platform 110. In another embodiment, the discount organization and the real estate entity may both be separate entities. In some embodiments, the discount organization and the real estate entity may form a joint venture or some other type of business arrangement. In one embodiment, a tenant of the real estate management platform 110 may become a customer of the banking platform 102 in order to obtain the opportunity to have the tenant's rent amount adjusted based on the tenant's activity. Unless otherwise noted, in the following disclosure, the term “customer” may refer to an entity that is both (1) an employee of an employer who is a member of the discount organization, and (2) a tenant of the real estate management platform 110.

In some embodiments, the discount organization may own, operate, control, use, or otherwise be associated with the price adjustment platform 112. The price adjustment platform 112 may include one or more computing devices. The price adjustment platform 112 may receive customer payment data from the banking platform 102, the merchant platform 108, or other data sources. The price adjustment platform 112 may receive other types of data about the customer from the banking platform 102, the merchant platform 108, or other data sources. The price adjustment platform 112 may analyze the customer's activities as indicated by the received data and convert the activities into a standardized format. The standardized format may include a point balance corresponding to the customer.

The price adjustment platform 112 may maintain a point balance for the customer. The price adjustment platform 112 may automatically determine whether the customer data satisfies one or more predetermined conditions. In response to the received data indicating that the customer has fulfilled one or more predetermined conditions, the price adjustment platform 112 may adjust the customer's point balance as tracked and maintained by the price adjustment platform 112. In one or more embodiments, a predetermined condition may include the customer making payments to the merchant platform 108. For example, the price adjustment platform 112 may increase a customer's point balance by one point for each dollar the customer spends using the payments platform 106. For example, the customer may spend $100 using the payments platform, and the price adjustment platform 112 may increase the customer's point balance by 100. In some embodiments, a predetermined condition may include the customer making payments at one or more predetermined merchants. For example, the banking platform 102, the price adjustment platform 112, or some other computing platform may provide the customer a list of merchant entities, and the customer making payments of $137 at one or more of the listed merchant entities may result in the price adjustment platform increasing customer's point balance by 137 points, and the customer making payments to a merchant entity not listed may not result in the price adjustment platform increasing the customer's point balance. In another embodiment, a predetermined condition may include the customer spending money at one or more merchant entities at least a predetermined amount of times. In response, the price adjustment platform 112 may increase the customer's point balance. For example, the customer making payments to merchant entities at least ten times may result in the price adjustment platform 112 increasing the customer's point balance. In one embodiment, the customer using or purchasing goods or services from the banking platform 102 may increase the customer's point balance on the price adjustment platform 112. For example, in response to the customer taking out a loan or opening a savings account, the price adjustment platform 112 may increase the customer's point balance.

In response to the customer's point balance satisfying predetermined criteria, or in response to the received data otherwise satisfying predetermined criteria, the customer may achieve a certain status in the price adjustment platform 112. The status of the customer may depend on the customer's point balance, and the higher the point balance of the customer, the higher the customer's status may be. Different statuses may include different benefits that the discount organization may offer the customer. In some embodiments, the price adjustment platform 112 may send a notification to the real estate management platform 110 in response to the customer achieving a certain status, and the real estate management platform 110 may adjust a rent price associated with the customer.

In one embodiment, the predetermined criteria may include the customer's point balance reaching at least a predetermined amount. For example, the predetermined criteria may include the customer's point balance reaching at least 1,000 points. In some embodiments, the predetermined criteria may include a time interval in which the predetermined criteria can be satisfied. For example, the predetermined criteria may include the customer's point balance reaching at least 800 within a calendar month. In some embodiments, the predetermined criteria may include a time interval for which the predetermined criteria can be maintained. For example, the predetermined criteria may include the customer's point balance reaching at least 1,000 each calendar month for one year. If the customer's point balance does not accumulate 1,000 points during one calendar month during the year-long period, then the predetermined criteria may not be satisfied. In some embodiments, the predetermined criteria may include the customer payment data indicating that the customer payment data fulfills one or more of the predetermined conditions listed above (e.g., in a price adjustment platform 112 that may not use a points system).

In one embodiment, in response to the customer's point balance satisfying predetermined criteria or in response to the received data otherwise satisfying predetermined criteria, the price adjustment platform 112 may send a notification to the real estate management platform 110. The notification may include data describing that the customer has satisfied the predetermined criteria. The real estate management platform 110 may adjust the rent of the customer based on the notification. For example, in response to receiving a notification that the customer has accumulated 1,000 points, the real estate platform 110 may lower the customer's rent by 10%.

In some embodiments, the real estate platform 110 may receive multiple notifications from the price adjustment platform 112, and the real estate platform 110 may combine rent amount adjustments. For example, the price adjustment platform 112 may send a first notification to the real estate platform 110 indicating that the customer's point balance has reached at least 1,000 points. In response, the real estate platform 110 may reduce the customer's rent by 10%. In response, receiving a second notification that the customer's point balance has reached at least 2,000 points, the real estate platform 110 may further lower the customer's rent by 10% (a total reduction of 20%).

In some embodiments, the customer's point balance may need to continue to accumulate a predetermined amount of points in order to continue receiving the rent adjustment from the real estate platform 110. For example, in response to the customer accumulating at least 1,000 points each month for one year, the price adjustment platform 112 may send a notification to the real estate platform 110, and the real estate platform 110 may lower the customer's rent by 10%. Afterwards, in response to the customer's point balance not reaching at least 1,000 during a month-long period, the price adjustment platform 112 may send a second notification to the real estate platform 110, and the real estate platform 112 may adjust the customer's rent amount to the full amount (i.e., the customer no longer receives the 10% rent reduction).

In some embodiments, the price adjustment platform 112 may determine the rent adjustment the customer may receive. The rent adjustment amount may be included in the notification sent to the real estate platform 110. In other embodiments, the real estate platform 110 may determine the rent adjustment amount, and the notification may include the customer's point balance or other payment activity data sent by the price adjustment platform 112.

In one or more embodiments, the predetermined criteria may be customized to the customer. For example, a first customer's predetermined criteria may include the customer's point balance reaching at least 800, whereas a second customer's predetermined criteria may include the second customer's point balance reaching at least 1,200. The customization may be based on customer information. In some embodiments, the customer may provide at least some of the customer information. For example, the customer may input the customer information during a signup process at the banking entity.

The customer information may include one or more characteristics of the customer. A characteristic may include the type of entity the customer may be, an account balance the customer has with the banking platform 102, the size or type of property the customer rents, the customer's income/revenue or other financial information, or other characteristics of the customer. For example, in the above example, the first customer may include an individual natural person, a customer with a lower bank account balance, or a tenant for a residential property, and the second customer may include a business entity, a customer with a higher bank account balance, or a tenant of a commercial property. In some embodiments, an algorithm, computer model, or some other computational function may customize the predetermined criteria to the customer.

In some embodiments, the predetermined rent adjustment amount may be customized to the customer. The customization may be based on information about the customer. The customization may be based on the type of entity the customer may be. For example, the real estate management platform 110 may lower the rent more for an individual natural person customer than a business entity customer. The customization may be based on an account balance the customer has with the banking platform 102. For example, the real estate management platform 110 may lower the rent more for a customer that has more money in a bank account of the banking platform 102 than a customer with a lower bank account balance. The customization may be based on the size or type of real estate property the customer is a tenant of. For example, the real estate management platform 110 may lower the rent more for a customer renting a residential property than a commercial property. In another example, the real estate management platform 110 may lower the rent more for a customer renting a smaller-sized property than a customer renting a larger property.

In one embodiment, certain merchant entities may pay one or more fees to the entity that uses the banking platform 102. The one or more fees may include an interchange fee. The one or more fees may include a commission. The merchant entity may pay the banking entity a commission in exchange for the banking entity encouraging its customers to purchase goods or services from the merchant entity.

In some embodiments, other benefits made possible by the discount organization may include discounted prices for products or services, discounted member spaces, or discounted member hubs. In some embodiments, these benefits may be provided by the discount organization itself, a merchant entity, a real estate entity, or some other entity. For example, a customer with a certain status on the price adjustment platform 110 may receive a discount at a printing merchant for printing, copying, shipping, or office supply products and services. The customer with the status may receive a discount at a restaurant merchant entity for coffee, food, or beverages products. The customer with the status may receive a discount at a property of the real estate entity that provides meeting spaces (such as a meeting room, private movie theater, or other on-demand space).

In some embodiments, the customer may use the payments platform 106 to pay for goods and services even before the customer begins to rent property from the real estate entity. In this manner, the customer can accumulate points and save them and can achieve a status even before moving to the location where the discounted rent is needed. By saving more points and status, a customer may be able to plan for a longer desired tenancy at the affordable rates provided via participation in the system 100. Such accumulation behavior by individual customers may also benefit the discount organization, investors, owners, or landlords because it may allow forecasting of future demand, and may create a captive demand for development of affordable real estate as customers seek to redeem rent reductions at some point in the future for points earned.

In some embodiments, the discount organization or real estate entity may provide customers with lease options according to the status level of the customer as determined by the price adjustment platform 112. For example, when the customer signs up to participate in the system 100, the customer may have a desired rental size in mind. The customer may select a space category including a grouping of available units in a specific size range. Different space categories may require different statuses, so a customer with a lower status (e.g., based on point balance) may only be able to see a subset of all available space categories. On the other hand, a customer with a higher status may have access to additional space categories. A business with more revenue or income may be able to earn more points and status, and in turn may be able to access larger space categories. In some embodiments, available space categories may also be filtered based on customer characteristics, such as retail, food and beverage, storage, etc.

In one embodiment, one or more components of the system 100 may be in data communication via a data network. The data network may include a local area network (LAN), a wide area network (WAN), an Internet service provider (ISP), the Internet, a wireless network, a wired network, or some other type of network. The data network may facilitate the data communication between one or more computing devices, systems, or platforms.

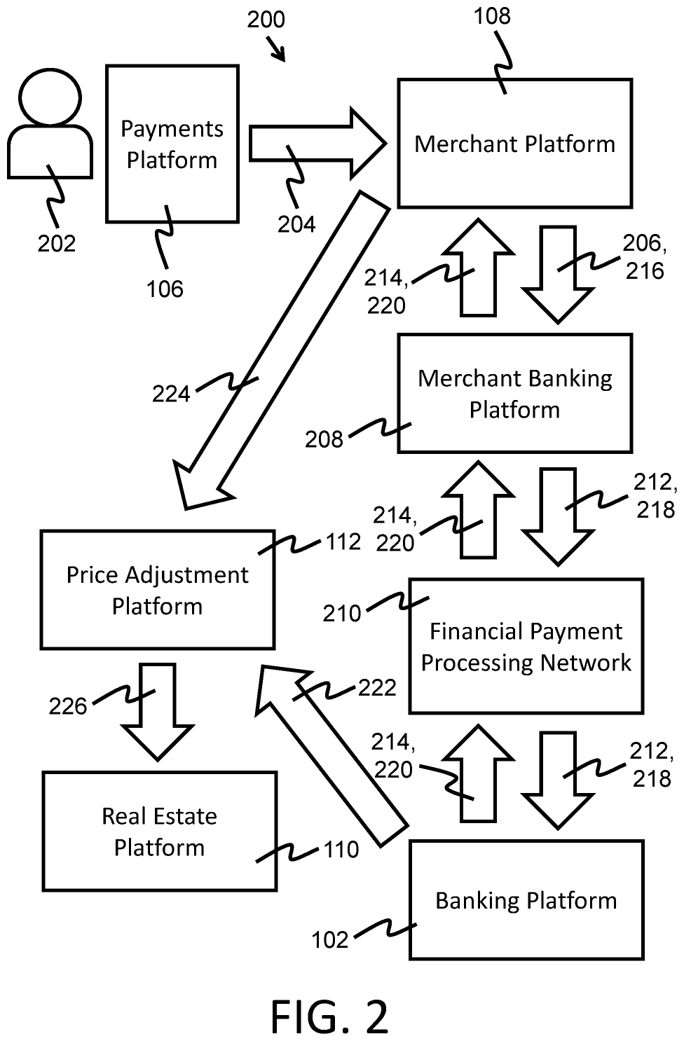

FIG. 2 depicts one embodiment of data flow through the system 100. The customer 202 may use the payments platform 106 to make a payment to the merchant platform 108. For example, a mobile payment application or digital wallet application may send radio frequency identification (RFID) or near-field communication (NFC) signals to a wireless receiver of a POS terminal of the merchant platform 108, and the signals may include authorization data 204 used to authorize payment. Or, the customer may swipe the customer payment card at a payment card reader of the POS terminal, and the card reader may receive the authorization data 204 via the magnetic strip or a chip of the customer payment card. The authorization data 204 may include a debit/credit card number, a personal identification number (PIN), expiration date, card security code, bank account number, routing number, or other data used in authorizing the transaction.

The merchant platform 108 may send an authorization request 206 to a merchant banking platform 208 that may include the authorization data 204. The merchant banking platform 208 may be part of a merchant banking entity, which may include a financial institution that may be part of a financial payment processing network 210 (e.g., a credit card network), that the merchant entity may have previously established a bank account with. The POS terminal may communicate electronically with one or more transaction processing computers of the merchant banking platform 208 to send the authorization request 206 to the merchant banking platform 208. In some embodiments, the merchant banking platform 208 may authorize a third party (such as an entity that forms part of the financial payment processing network 210) to perform transaction processing on its behalf, in which case the POS terminal may communicate with the third party's payment system. The merchant banking platform 208 or third party may communicate 212 with the banking platform 102 to authorize the transaction. Authorizing the transaction may include the banking platform 102 determining whether the customer's 202 account with the banking platform 102 is in good standing, whether the customer's 202 current credit line or bank account balance is sufficient for the purchase amount, or other determinations. The banking platform 102 may send a response 214 to the merchant platform 108 via the financial payment processing network 210 and the merchant banking platform 208 or the third party.

If the response 214 includes data approving the transaction, the POS terminal may store the transaction for clearance and settlement. The merchant platform 108 may send the stored transaction (along with other stored transactions) 216 to the merchant banking platform 208, which may route the transaction information 218 to the financial payment processing network 210 for settlement. The financial payment processing network 210 may send the transaction information 218 to the banking platform 102, and the banking platform 102 may send payment 220 to the merchant banking platform 208. The banking platform 102 may deduct the transaction amount from the customer's 202 credit line, bank account balance, etc. as maintained by the banking platform 102.

The banking platform 102 may send customer payment data 222 to the price adjustment platform 112. The customer payment data 222 may include data about the customer's 202 payments as based on the received transaction information 218. The customer payment data 222 may include a customer identifier. The customer identifier may uniquely identifier the customer 202. The customer identifier of the customer payment data 222 may include the same customer identifier as that stored in a database of the price adjustment platform 112 (such as the database 506, discussed below), or may include a different customer identifier that is associated with the customer identifier stored in the database 506. The customer payment data 222 may include one or more payment transactions. Each payment transaction may include data included in a received transaction. This may include the transaction amount (i.e., the amount the customer 202 paid the merchant), a merchant identifier (which may include an identification of the merchant entity where the transaction took place), the date the customer 202 paid the merchant, or other data.

In some embodiments, the merchant platform 108 may send customer purchase data 224 to the price adjustment platform 112. The customer purchase data 224 may include data about the customer's 202 purchases. The customer purchase data 224 may include a customer identifier (which may be the same as or different from the customer identifier of the customer payment data 222 or the account identifier of the database 506). The customer purchase data 224 may include one or more purchase transactions. Each purchase transaction may include the amount of money the customer 202 spent, data indicating at least some of the goods/services the customer 202 purchased, the date the customer 202 made the purchase, or other data associated with the customer's 202 purchases at the merchant entity. The data indicating the goods/services the customer 202 purchased may include an identifier of the specific goods/services purchased, a category of the goods/services purchased, or other data. The customer purchase data 224 may include a merchant identifier (which may be the same as or different from the merchant identifier of the customer payment data 222).

The price adjustment platform 112 may analyze the customer payment data 222 or the customer purchase data 224 and adjust the customer's 202 point balance. In response to the customer's 202 point balance satisfying predetermined criteria, such as exceeding a predetermined point amount, the price adjustment platform 112 may send a notification 226 to the real estate platform 110, and the real estate platform 110 may adjust the rent amount of the customer 202.

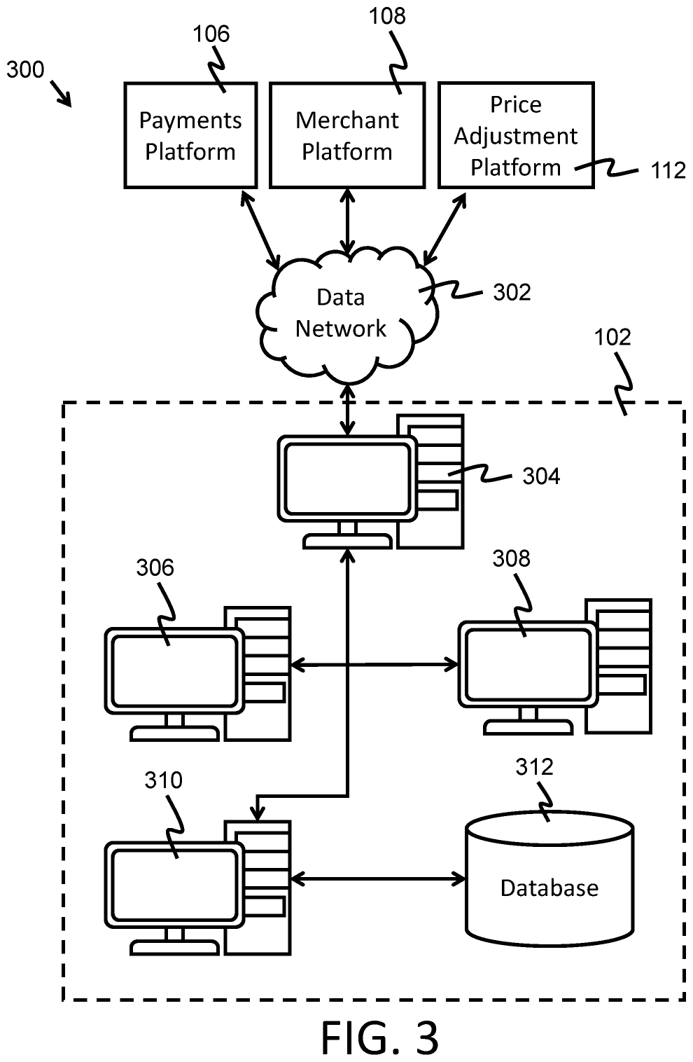

FIG. 3 depicts one embodiment of a system 300. The system 300 may include the payments platform 106, the merchant platform 108, the price adjustment platform 112, a data network 302, or the banking platform 102. The banking platform 102 may include a web server 304, an application server 306, a payment processing server 308, a database server 310, or a database 312.

In one embodiment, the data network 302 may include a LAN, a WAN, an ISP, the Internet or some other type of network. The data network 302 may provide data communication between the banking platform 102 and one or more other devices (e.g., the customer device 104, the merchant platform 108, or the price adjustment platform 112). The data network 302 may be in data communication with one or more computing devices of the banking platform 102. For example, as depicted in FIG. 3, the web server 304 may be in data communication with the data network 302. In some embodiments, other computing devices of the banking platform 102 may also be in data communication with the data network 302.

The web server 304 may include a computing device. The web server 304 may provide a gateway between the data network 302 and other computing devices of the banking platform 102 (e.g., the application server 306, the payment processing server 308, the database server 310, or the database 312). The web server 304 may receive data packets from the data network 302 and forward them to the appropriate computing device of the banking platform 102. The web server 304 may receive data packets from the computing devices of the banking platform 102 and forward them to the data network 302.

The web server 304 may include a website. The website may include one or more webpages. The one or more webpages may include static webpages or dynamic webpages. The web server 304 may generate a dynamic webpage using data received from the application server 306 or the database server 308. The customer device 304 may access the website to access banking services or functionality (e.g., checking a bank account balance, transferring money between bank accounts, pay off a credit card balance, etc.).

In one embodiment, the application server 306 may include a computing device. The application server 306 may include software that carries out banking services and functionality. For example, the application server 306 may adjust bank account balances, transfer money between bank accounts, track and store bank transactions, etc. The application server 306 may carry out banking services or functionality in response to receiving a request from the web server 304 (e.g., the web server 304 received a request from a customer to carry out the banking services or functionality), in response to a request from a computer terminal of the banking platform 102, or in response to some other functionality.

The payment processing server 308 may include a computing device. The payment processing server 308 may include software that carries out payment processing functionality. The payment processing functionality may include transaction authorization or approving a transaction sent from the merchant platform 108, remitting payment during clearance and settlement, or other payment processing functionality. The payment processing server 308 may send data to or receive data from other computing devices of the banking platform 102 in order to carry out the payment processing functionality.

The database server 310 may include a computing device. The database server 310 may include software that defines, creates, maintains, or controls access to the database 312. The database server 310 may include a database management system (DBMS). The database server 310 may receive requests from other computing devices of the banking system 102 to read data from the database 312, insert data into the database 312, update data in the database 312, or remove data from the database 312. The database 312 may include a database residing on the database server 310 or stored on a separate storage device.

The database 312 may include a relational database, an object-oriented database, a document-oriented database, or some other type of database. The database 312 may store data related to the banking services or functionality. The database 312 may include bank account data (e.g., bank account balances, bank account transactions, etc.), payment processing data (e.g., transactions received from the merchant platform 108, transactions authorized or approved by the payment processing server 308, etc.), or other data.

As an example of the banking platform's 102 functionality during the data flow depicted in FIG. 2, the web server 304 may receive an authorization request 206 from the data network 302 (which may have been sent by the merchant platform 108 via the merchant banking platform 208 or the financial payment processing network 210). The web server 304 may send the authorization request 206 to the payment processing server 308. The payment processing server 308 may read the transaction amount, the debit card number, and the PIN from the authorization request 206. The payment processing server 308 may send the debit card number to the database server 310 to request the current account balance, the PIN, and the status of the account associated with the debit card number in the database 312. The database server 310 may use the received debit card number to access the requested data and send the data to the payment processing server 308. In response to the PIN received in the authorization request 206 matching the PIN received from the database 312, the account balance received from the database 312 having sufficient funds, and the bank account status received from the database 312 indicating that the account is in good standing, the payment processing server 308 may send a response 214 to the web server 304. The response 214 may include data approving the transaction. The web server 304 may send the response 214 to the data network 302 to be forwarded to the merchant platform 108. The payment processing server 308 may send a request to the database server 310 requesting that the checking account balance associated with the debit card number be reduced by the transaction amount. The payment processing sever 308 may send the transaction data (including the transaction amount and the identity of the merchant) to the web server 304 to be forwarded to the price adjustment platform 112 as customer payment data 222.

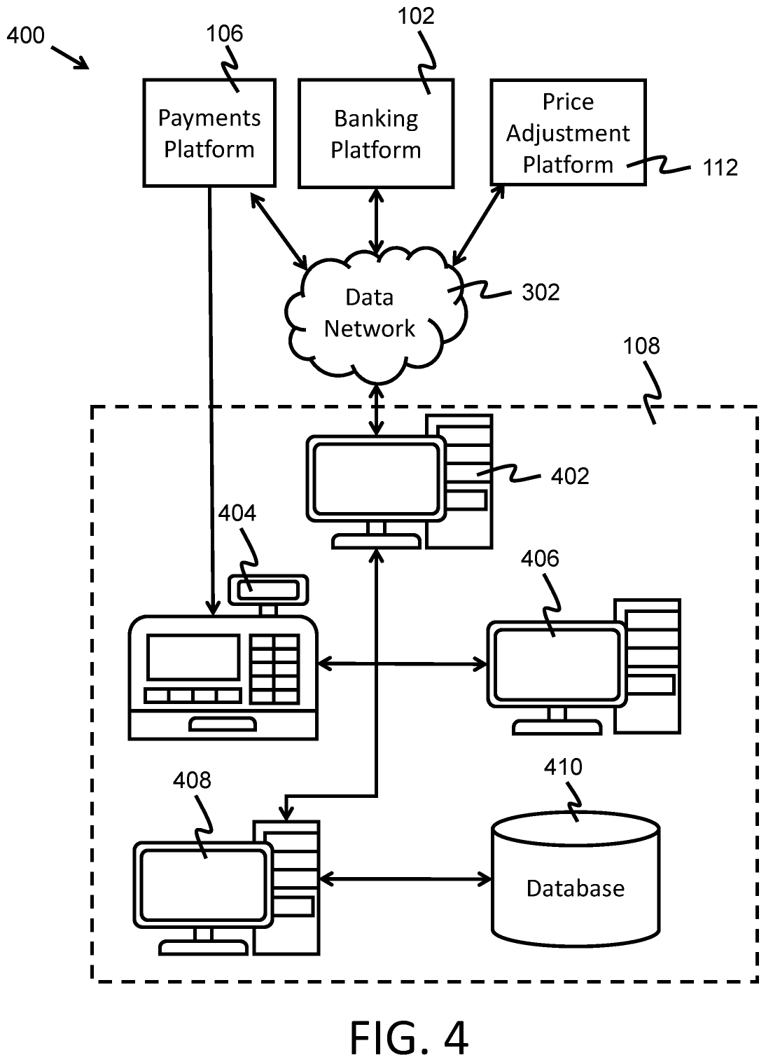

FIG. 4 depicts one embodiment of a system 400. The system 400 may include the banking platform 102, the payments platform 106, the price adjustment platform 112, the data network 302, or the merchant platform 108. The merchant platform 108 may include a web server 402, a POS terminal 404, an application server 406, a database server 408, or a database 410.

The web server 402 may include similar functionality to the web server 304 of the system 300 (e.g., forwarding data packets, providing access to a website, etc.). In some embodiments, a webpage of a website of the web server 402 may include a webpage that accepts payment information from the customer 202. The payment information may include a payment card number, an address, an expiration date, a security code, or other payment information. The web server 402 may receive the payment information in one or more data packets.

The POS terminal 404 may include a cash register, a payment card reader, or a computing device. The payment card reader may include a magnetic stripe reader, a chip reader, or a wireless terminal. The wireless terminal may include an RFID transceiver, an NFC transceiver, or some other type of wireless transceiver. The payment card reader may obtain the authorization data 204 from the payments platform 106 (e.g., from a customer payment card or a digital wallet application of the customer device 104). The POS terminal 404 may generate a transaction that includes at least a portion of the authorization data 204. The POS terminal 404 may send the transaction in an authorization request 206 to the web server 402 to be sent to the banking platform 102 via the data network 302 for transaction authentication or approval. The POS terminal 404 may receive the response 214 approving the transaction from the banking platform 102 via the data network 302 or the web server 402. The POS terminal 404 may send sales data to the application server 406 or to the database server 408 for storage in the database 410. The sales data may include at least a portion of the authorization data 204, the amount of the customer's 202 purchase, the goods/services the customer 202 purchased, a customer's 202 membership identifier of the merchant's loyalty program, or other sales data related to the customer's 202 purchase.

In some embodiments, the POS terminal 404 may receive a membership identifier of the merchant's loyalty program. The customer 202 or an employee of the merchant entity may input the identifier into the computing device of the POS terminal 404 or the customer 202 may scan a card including the membership identifier using a scanner of the POS terminal 404. The POS terminal 404 or another computing device may associate the membership identifier with the sales data.

The application server 406 may include a computing device. The application server 406 may include software including inventory management software, customer relations management software, financial software, warehousing software, or other software. The application server 406 may include banking partnership software. The banking partnership software may include functionality that tracks sales data or other purchase information associated with customers 202 of the banking platform 102 and real estate platform 110 and converts the sales data or purchase information into the purchase data 224. The banking partnership software may send the purchase data 224 to the price adjustment platform 112.

The database server 408 may include a computing device. The database server 408 may include similar software or functionality to the database server 310 of the system 300. The database 410 may include a database similar to the database 312 of the system 300. However, the database 410 may not maintain data about banking services and functionality, but may instead maintain data about the merchant entity. The database 410 may include inventory data, purchase data, customer relations data, or other data. The purchase data may include the identity of the customer (as indicated by a username, a payment card identifier such as a payment card number, the membership identifier of the merchant's loyalty program, etc.), a transaction amount, the goods/services purchased, the time/date of purchase, the location of the purchase, or other data.

In one embodiment, the banking partnership software of the application server 406 may include functionality that tracks purchase information about customers 202. The banking partnership software may determine whether sales data is associated with a customer 202 of the banking platform 102 and the real estate management platform 110. The application server 406 may maintain a profile for each customer in the merchant's membership loyalty program, and the profile may include data indicating that a customer is a customer 202 of the banking platform 102 and real estate platform 110. The application server 406 may maintain a list of payment information for the payments platform 106, payment card numbers or payment card identifiers (in the case where the merchant platform 108 does not store payment card numbers for security purposes) received from the banking platform 102 indicating that the sales data associated with the payment information, payment card numbers, or identifiers is associated with a customer 202. Once the banking partnership software determines whether sales data is associated with a customer 202, the banking partnership software may convert the sales data into customer purchase data 224 and send the customer purchase data 224 to the price adjustment platform 112.

As an example of the merchant platform's 108 functionality during the data flow depicted in FIG. 2, the customer 202 may make a purchase at the POS terminal 404. The POS terminal 404 may scan the purchased items, the employee of the merchant may input the customer's 202 membership identifier, and the customer 202 may use the payments platform 106 to make a payment. The payment card reader of the POS terminal 404 may receive the authentication data 204 from the payments platform 106. The POS terminal 404 may send at least a portion of the authentication data 204 in the authentication request 206 to the banking platform 102 via the web server 402, the data network 302, the merchant banking platform 208, or the financial payment processing network 210. The POS terminal 404 may receive the response 214 approving the transaction. The POS terminal 404 may send the sales data to the database server 408 to be stored in the database 410. The sales data may include the customer's membership identifier, the transaction amount, the goods/services purchased, or other data. The application server 406 may retrieve the sales data from the database 410 by requesting it from the database server 408. The application server 406 may use the banking partnership software to determine that the sales data corresponds to a customer 202 of the banking platform 102 and the real estate platform 110. The banking partnership software may determine that the customer profile associated with the membership identifier of the sales data includes data indicating that the customer is a customer 202 of the banking platform 102 and real estate platform 110. In response, the banking partnership software may convert the sales data into the customer purchase data 224 and send the customer purchase data 224 to the web server 402. The web server 402 may send the customer purchase data 224 to the price adjustment platform 112 via the data network 302.

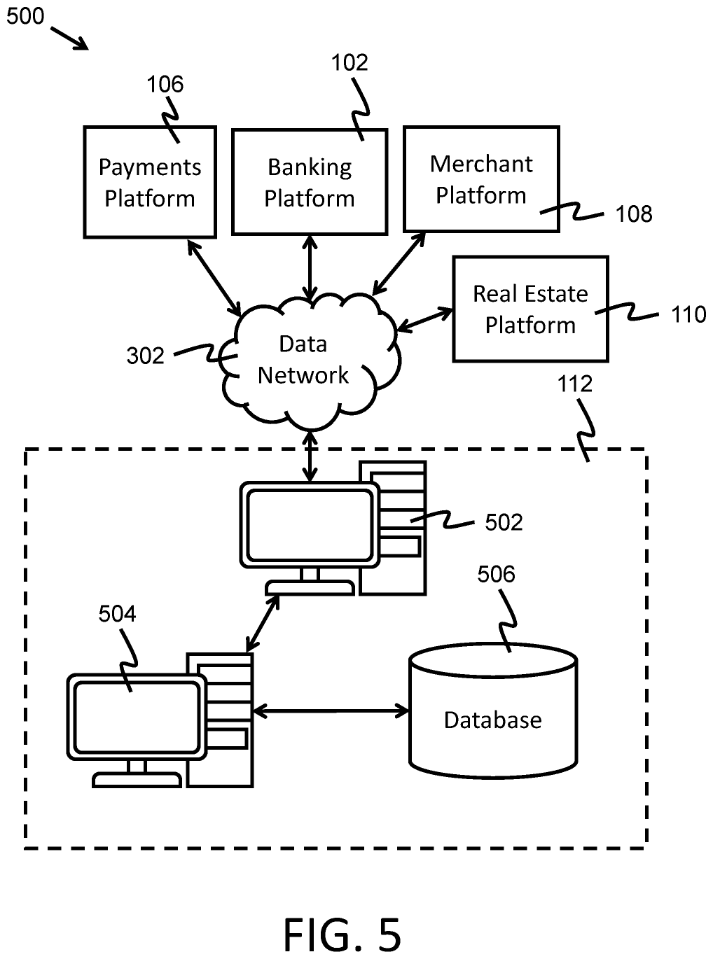

FIG. 5 depicts one embodiment of a system 500. The system 500 may include the banking platform 102, the payments platform 106, the merchant platform 108, the data network 302, or the price adjustment platform 112. The price adjustment platform 112 may include a web server 502, an application server 504, or a database 506.

In some embodiments, the web server 502 may include similar functionality to the web server 304 of the system 300 or the web server 402 of the system 400 (e.g., forwarding data packets, providing website access, etc.). The application server 504 may include a computing device. The computing device may include one or more computer-readable storage media. The storage media may include executable instructions stored thereon. The application server 504 may include software. The software may include the one or more executable instructions. The computing device may include one or more computer processors that may be configured to perform various functions in response to executing the executable instructions. The various functions may include executing the software.

The software of the application server 504 may include points adjustment software. The points adjustment software may include functionality to receive payment data 222 from the banking platform 102 or purchase data 224 from the merchant platform 108. The points adjustment software may include functionality to analyze the received data and adjust a customer's 202 point balance or may otherwise automatically determine whether the received data fulfills one or more predetermined conditions. The points adjustment software may include functionality to send a notification 226 to the real estate platform 110 in response to the customer's 202 point balance satisfying predetermined criteria.

The database 506 may be similar to the database 312 of the system 300 or the database 410 of the system 400. The database 506 may be configured to store one or more customer accounts. A customer account may include data about a customer of the system 100. The customer account may include an account identifier. The account identifier may include an identifier that may uniquely identify the customer 202 or the customer account from other customers 202 or customer accounts. The account identifier may include an identification number, a username, an email address, or some other identifier. The customer account may include a customer's 202 point balance.

The database 506 may store customer data, including at least some of the customer's 202 customer payment data 222, customer purchase data 224, or other customer 202 data. In some embodiments, the price adjustment platform 112 may include a database server (not depicted in FIG. 5) that may include similar functionality to the database server 310 of the system 300 or the database server 408 of the system 400.

The database 506 may be further configured to store one or more merchant identifiers. The merchant identifiers stored in the database 506 may include merchant identifiers that correspond to merchant entities associated with the discount organization. The database 506 may store the merchant identifiers in order to compare customer payment 222 or customer purchase data 224 against to determine whether the customer 202 has made a purchase at a merchant entity that is associated with the discount organization. In response to the customer making a purchase at a merchant entity whose merchant identifier is stored in the database 506, the points adjustment software may calculate the customer's 202 point increase differently than if the customer had made a purchase at a merchant entity whose merchant identifier is not stored in the database (and, thus, may not be associated with the discount organization), as described herein.

In one embodiment, the customer 202 may use the customer device 104 to access the web server 502. For example, the customer device 104 may include a software application or a web browser in data communication with the web server 502. The customer device 104 may access the web server 502 to check the customer's 202 point balance. The customer device 104 may access the web server 502 to check the customer's 202 point history or point transactions (which may be derived from or based on the received customer payment data 222 or customer purchase data 224).

The point adjustment software may receive customer data (including customer payment data 222 or customer purchase data 224) and convert the customer payment data 222 to points and increase the customer's 202 point balance by the point amount. The point adjustment software may include programming logic that may include point conversion rates. The point adjustment software may convert the customer payment data 222 or the customer purchase data 224 to points based on a conversion rate. The conversion rates may include a payment amount-to-points conversion rate that may convert an amount of money the customer 202 spent (as contained in the payment data 222) to points (e.g., 1 point per dollar spent). The conversion rates may include a merchant-to-points conversion rate that may convert an amount of times the customer 202 spent money (as contained in the payment data 222 or purchase data 224) at a certain merchant entity to points (e.g., 10 points per instance that the customer 202 shopped at the merchant entity). The conversion rates may include a goods/services-to-points conversion rate that may convert whether the customer 202 purchased a particular good or service (as contained in the purchase data 224) to points (e.g., 5 points per gallon of gasoline purchased).

The programming logic may include one or more point amounts that form a part of the predetermined criteria that may cause the price adjustment system 112 to send the notification 226 to the real estate platform 110.

As an example of the price adjustment platform 112 functionality during the data flow depicted in FIG. 2, the web server 502 may receive customer payment data 222 and customer purchase data 224 from the data network 302. The customer payment data 222 may have been sent by the banking platform 102, and the customer purchase data 224 may have been sent by the merchant platform 108. The customer payment data 222 may include a payment transaction that includes the payment date (Jan. 14, 2020), the identity of the merchant entity (Merchant A), and the amount the customer 202 spent ($35.14). The customer purchase data 224 may include a purchase transaction that includes the purchase date (Jan. 14, 2020), the amount the customer 202 spent ($35.14), and the goods/service purchased (groceries).

Continuing the example, the application server 504 may receive the customer payment data 222, the customer purchase data 224, or data based on the customer payment data 222 or the customer purchase data 224 (hereafter referred to as “received data 222, 224” in this example). The application server 504 may execute the point adjustment software. The point adjustment software may receive the received data 222, 224. The point adjustment software may use the programming logic and point conversion rates to convert the received data 222, 224 to points. The point adjustment software may take the payment transaction, extract the amount the customer spent (i.e., $35.14), and apply the payment amount-to-points conversion rate (i.e., 1 point per dollar spent) to generate 35 points. The points adjustment software may take the payment transaction, extract the merchant entity identity (i.e., Merchant A), and apply a merchant-to-points conversion rate (i.e., 10 points for shopping at Merchant A) to generate 10 additional points. The point adjustment software may take the purchase transaction, extract the goods/services purchased (i.e., groceries), and determine that groceries do not have a good/service-to-points conversion rate. Thus, the total points generated include 45 points.

Continuing the example, the point adjustment software may obtain the customer's 202 point balance from the database 506, which in this example may be 980 points. The point adjustment software may add the generated points to the customer's 202 point balance to generate a new point balance of 1,025 points. The point adjustment software may compare the customer's 202 new point balance to predetermined point balances to determine whether the customer's 202 point balance satisfies at least one predetermined criteria. The predetermined criteria may include a 1,000 point balance. The point adjustment software may determine that the customer's point balance of 1,025 exceeds 1,000, and thus, satisfies the predetermined criteria. In response, the point adjustment software may generate a notification 226 and send the notification 226 to the web server 502, which may send the notification 226 to the data network 302 to be forwarded to the real estate platform 110. The notification 226 may include the customer's point balance of 1,025.

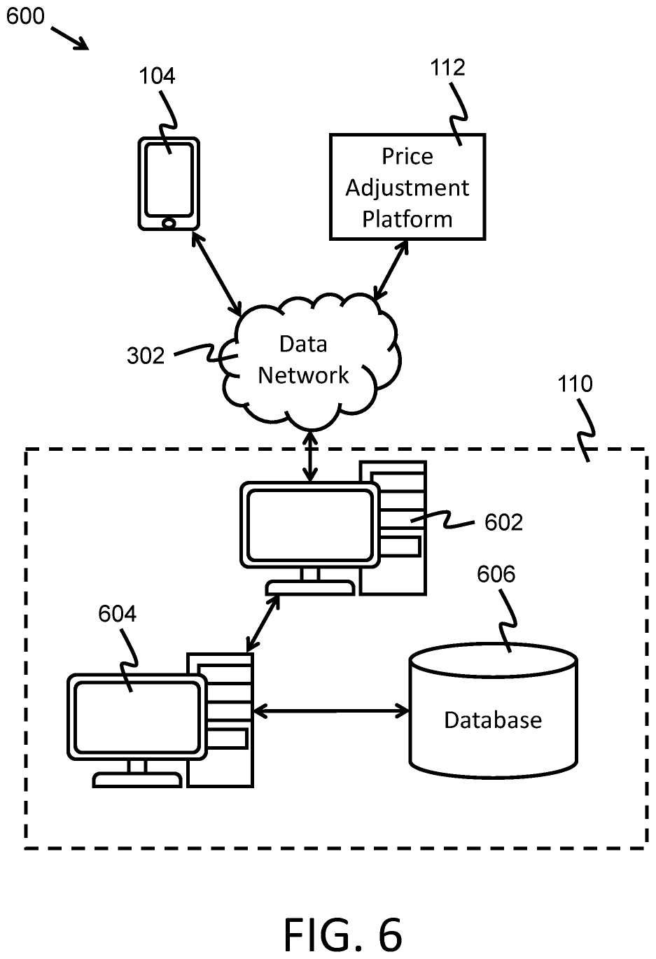

FIG. 6 depicts one embodiment of a system 600. The system 600 may include the customer device 104, the price adjustment platform 112, the data network 302, or the real estate platform 110. The real estate platform 110 may include a web server 602, an application server 604, or a database 606.

In some embodiments, the web server 602 may include similar functionality to the web server 304 of the system 300, the web server 402 of the system 400, or the web server 502 of the system 500 (e.g., forwarding data packets, providing website access, etc.). The application server 604 may include a computing device. The application server 604 may include software. The software may include real estate management software. The real estate management software may determine a rent amount for each occupied property managed by the real estate platform 110 and charge that amount to a tenant. At least a portion of the tenants as tracked by the real estate management software may include customers 202 of the banking platform 102 and the real estate platform 110.

The database 606 may be similar to the database 312 of the system 300, the database 410 of the system 400, or the database 506 of the system 500. However, the database 606 may store real estate data. The real estate data may include property data. The property data may include data about one or more properties. Each property may include a rent amount, the frequency at which rent is paid, the property's location, the property's amenities, the property's size, or other property information. The real estate data may include tenant data. The tenant data may include data about one or more customers 202. Each customer 202 may include one or more real estate properties that the customer 202 occupies, biographical data, financial data, correspondence data, or other data. Each property or customer 202 may include one or more adjusted rent amount.

The customer device 104 may access the web server 602 to check the customer's 202 tenant data or property data associated with the customer 202, including the customer's 202 rent balance (i.e., whether the customer 202 currently owes rent), a rent adjustment amount associated with the customer 202, rent payment history, or other data. In some embodiments, the real estate platform 110 may include a database server (not depicted in FIG. 6) that may include similar functionality to the database server 310 of the system 300 or the database server 408 of the system 400.

The real estate management software of the application server 604 may include programming logic that may adjust a rent amount associated with a customer 202 or property. The real estate management software may receive the notification 226 from the price adjustment platform 112. The real estate management software may use the programming logic to convert the notification 226 into a rent adjustment amount and adjust a customer's 202 rent amount by the rent adjustment amount.

As an example of the real estate platform 110 functionality during the data flow depicted in FIG. 2, the web server 602 may receive a notification 226 from the data network 302. The notification 226 may have been sent by the price adjustment platform 112. The web server 602 may send the notification 226 or data based on the notification 226 (hereinafter collectively referred to as the “notification 226”) to the application server 604. The application server 604 may use the real estate management software to determine the customer 202 associated with the notification 226 (e.g., the notification 226 may include a customer 202 identifier that may uniquely identify the customer 202 in the real estate platform 110). The application server 604 may retrieve property or tenant data from the database 606 associated with the identified customer 202.

Continuing the example, the real estate management software may determine a rent adjustment amount based on the received notification 226. The notification 226 may include a point amount of 1,025. The real estate management software may take the point amount of 1,025 and determine a rent adjustment amount based on the customer's 202 point amount. For example, the real estate management software may include a table that includes one or more point amounts and a rent adjustment amount associated with each point amount. For example, 1,000 points may be associated with a rent adjustment amount of 10%, 2,000 points may be associated with a rent adjustment amount of 20%, and 3,000 points may be associated with a rent adjustment amount of 25%. The table may be customized for the specific customer 202. The real estate management software may determine that the 1,025 point amount is at least 1,000 points but less than 2,000 points, and thus, the associated rent adjustment amount is 10%.

Continuing the example, the real estate management software may retrieve a rent amount associated with the customer 202 from the database 606. The rent amount may be $3,000 per month. The real estate management software may apply the rent adjustment amount (10%) to the rent amount ($3,000) to obtain the adjusted rent amount ($2,700). The real estate management software may store the adjusted rent amount in the database 606 associated with the customer 202. At the time of charging rent to the customer 202, the real estate management software may retrieve the adjusted rent amount from the database 606 and charge the customer 202 the adjusted rent amount of $2,700.

In some embodiments, certain components of the systems 300, 400, 500, or 600 may be in data communication in a different configuration than what is depicted in FIG. 3, FIG. 4, FIG. 5, or FIG. 6. For example, the POS terminal 404 of the system 400 may be in data communication with the data network 302, the merchant banking platform 208, or the financial payment processing network 210 without going through the web server 402. In one or more embodiments, functionality of a computing device may occur on a different computing device than as described above. For example, instead of the payment processing server 308 sending the transaction data to the price adjustment platform 112, the payment processing server 308 may send the transaction data to the application server 306, and the application server 306 may send the transaction data to the price adjustment platform 112. Other functionality may take place on different computing devices other than as described previously.

In some embodiments, the banking platform 102, the price adjustment platform 112, or the real estate platform 110 may be owned, operated, or otherwise controlled by the same entity. In such a case, some of the functionality of the web servers 304, 502, or 602, the application servers 306, 504, or 604, or the database servers 310 may be performed by a single application server or by one or more software programs executing on a single application server. Similarly, some of the data stored in the databases 312, 506, or 606 may be stored in a single database. Other configurations are contemplated within the scope of the disclosure. Some of the functionality of one platform 102, 108, 110, or 112 may be included in another platform 102, 108, 110, or 112.

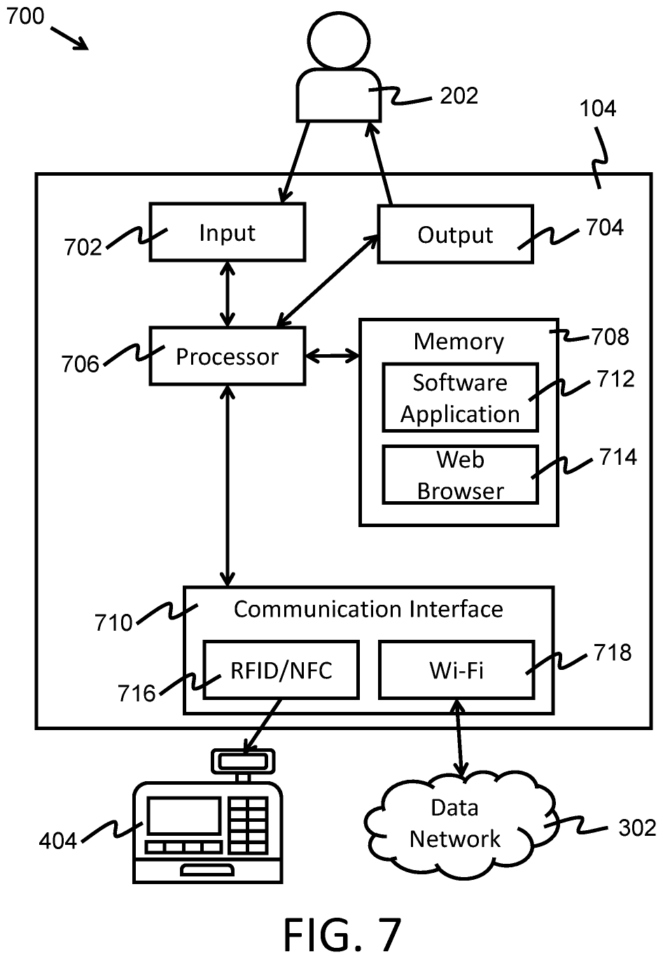

FIG. 7 depicts one embodiment of a system 700. The system 700 may include the customer 202. The system 700 may include the customer device 104. The customer device may include an input 702, an output 704, a processor 706, a memory 708, or a communications interface 710. The memory 708 may include a software application 712 or a web browser 714. The communications interface 710 may include a RFID transceiver/NFC transceiver 716 or a Wi-Fi transceiver 718. The system 700 may include the POS terminal 404 or the data network 302.

In some embodiments, the input 702 may include a touchscreen, a keyboard or mouse, one or more buttons, or other computer input-receiving components. The output 704 may include a touchscreen, a monitor screen, or some other type of computer output component. The processor 706 may include a central processing unit (CPU), graphical processing unit (GPU), a computer processor core, a multi-core processor, or some other type of computer processor. The memory 708 may include a non-transitory computer-readable storage medium. The memory 708 may include a random access memory (RAM), flash memory, hard disk drive, or some other type of computer storage device. The communications interface 710 may include a wireless or wired network interface or adapter.

The software application 712 may include one or more computer-readable instructions. The computer-readable instructions may be executed by the processor 706. When executed by the processor 706, the computer-readable instructions may cause the customer device 104 to request data from a web server (such as web server 304, 402, 502, or 602), receive data from the web server, and update the output 704 based on the received data. For example, the software application 712 may retrieve and display banking data associated with the customer 202 from the banking platform 102 (such as a bank account balance, transaction history, etc.). The software application 712 may retrieve and display merchant data (such as goods/services for sale, an account profile the customer 202 may have with a merchant, etc.). The software application 712 may retrieve and display price adjustment data from the price adjustment platform 112 (such as a transaction history or point balance). The software application 712 may retrieve and display real estate data (such as a rent adjustment amount, tenant data, or property data) from the real estate platform 110. In some embodiments, the software application 712 may include a mobile payment application or digital wallet application. The software application 712 may be downloadable to the customer device 104 from an application store (such as the Google Play Store or the Apple App Store). The web browser 714 may include a software application that may access data from the data network 302. The web browser 714 may include similar functionality to the software application 712, discussed above.

The RFID/NFC transceiver 716 may include a transceiver that may communicate wirelessly using an RFID or NFC frequency. The RFID/NFC transceiver 716 may send data from the software application 712 to the POS terminal 404. The data may include the authorization data 204. The Wi-Fi transceiver 718 may include a transceiver that may communicate wirelessly using a Wi-Fi frequency. The Wi-Fi transceiver 718 may send data from the software application 712 or web browser 714 to the data network 302. The data may include authentication data 204 or a request to a web server. The Wi-Fi transceiver 718 may receive data from the web server.

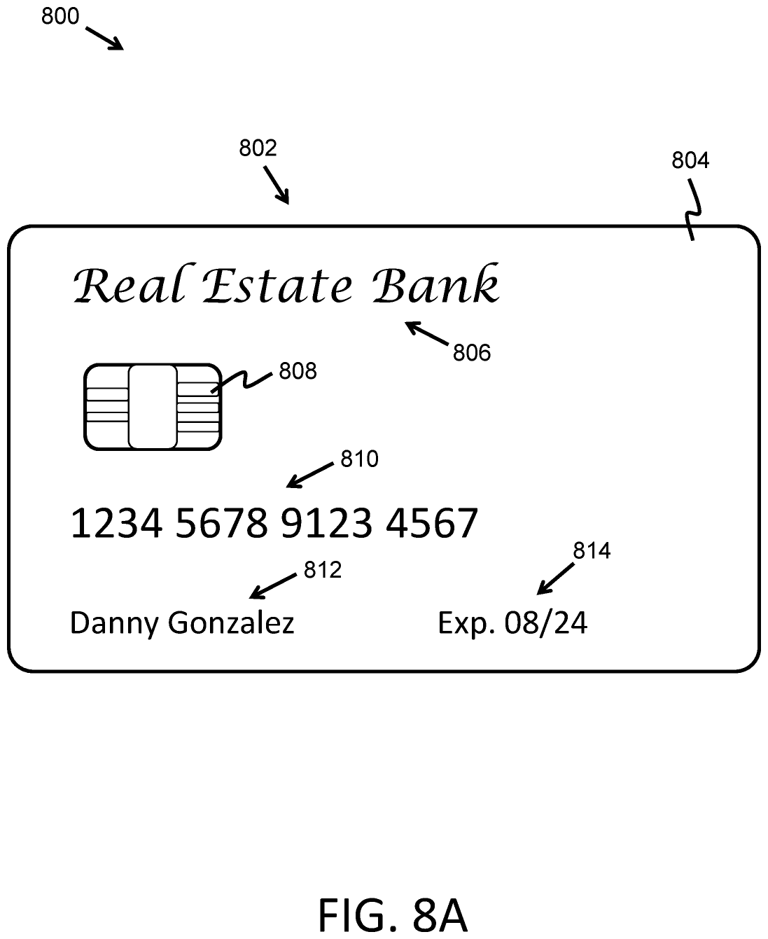

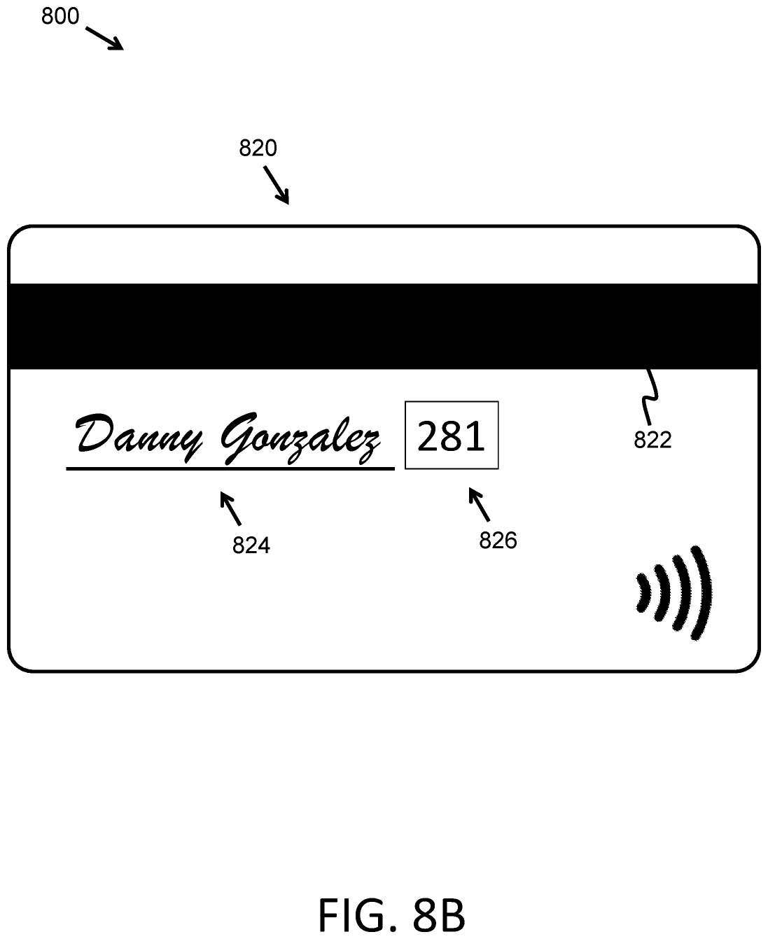

FIG. 8A depicts one embodiment of a customer payment card 800. The customer payment card 800 may include a front side 802. The customer payment card 800 may include a rigid material 804. The front side 802 may include a financial institution name 806. The customer payment card 808 may include a chip 808. The front side 802 may include a card number 810. The front side 802 may include a customer name 812. The front side 802 may include an expiration date 814.

In one embodiment, the rigid material 804 may include a plastic or other rigid material. The financial institution name 806 may include the name of the entity that owns, operates, or controls the banking platform 102. The chip 808 may include an integrated circuit chip. The chip 808 may include a Europay, Mastercard, and Visa (EMV) chip or some other type of integrated circuit chip. The chip 808 may include authentication data that may be readable by a chip reader of a POS terminal 404.

FIG. 8B depicts one embodiment of the customer payment card 800. The customer payment card 800 may include a backside 820. The backside 820 may include a magnetic stripe 822. The backside 820 may include a customer signature 824. The backside 820 may include a security code 826.

In one or more embodiments, the magnetic stripe 822 may include authentication data (e.g., the authentication data 204 of the system 200). A magnetic stripe reader of the POS terminal 404 may read the magnetic stripe 822 when the customer 202 swipes the customer payment card 800 through a magnetic card reader. In one embodiment, the customer payment card 800 may include a contactless smart card. The contactless smart card may include an integrated circuit that may include the authentication data. The integrated circuit may include an RFID or NFC antenna that may wirelessly communicate the authentication data to the POS terminal 404.

In some embodiments, some components of the front side 802 may be included on the backside 820 of the customer payment card 800. For example, the card number 810 or expiration date 814 may be included on the backside 820.

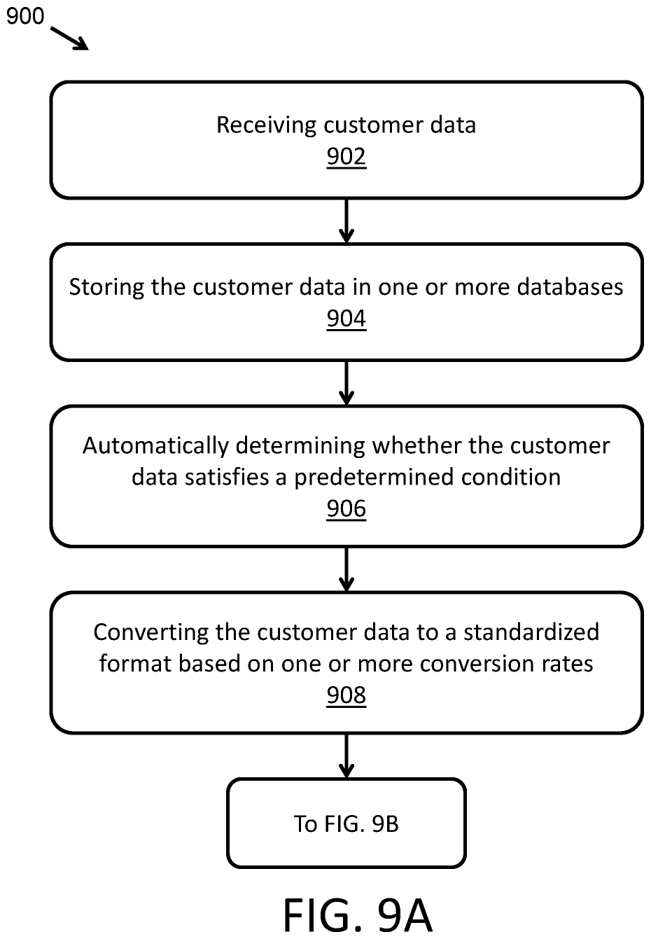

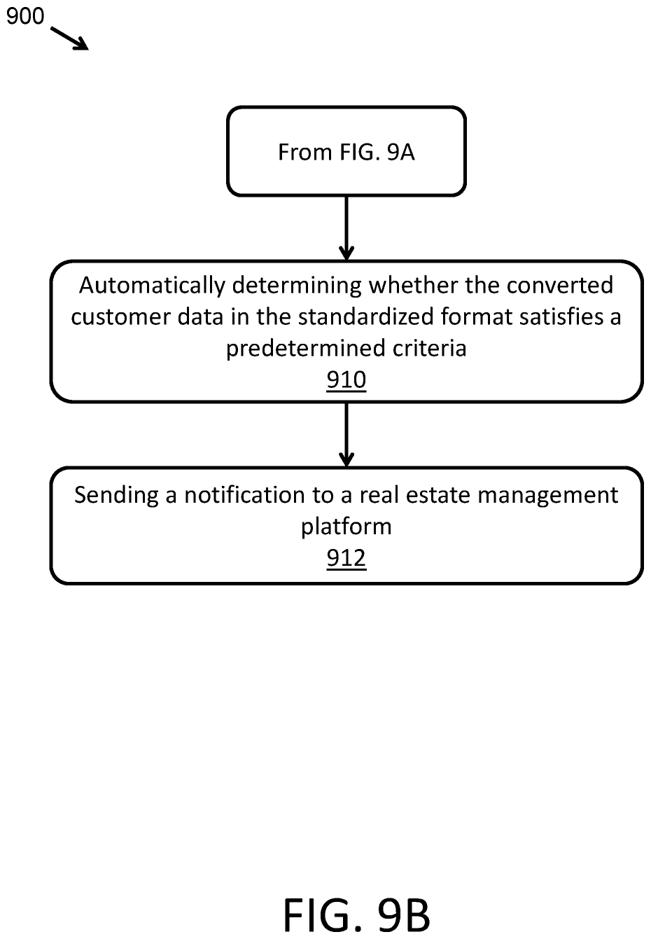

FIG. 9A and FIG. 9B depict one embodiment of a method 900. The method 900 may include a computer-implemented method for spend-based discount rent pricing for affordable real estate development. The method 900 may include receiving customer data (step 902). The method 900 may include storing the customer data in one or more databases (step 904). The customer data may be associated with an account identifier stored on the one or more databases. The method 900 may include automatically determining whether the customer data satisfies a predetermined condition (step 906). The method 900 may include, in response to the customer data satisfying the predetermined condition, converting the customer data to a standardized format based on one or more conversion rates (step 908). The method 900 may include automatically determining whether the converted customer data in the standardized format satisfies a predetermined criteria (step 910). The method 900 may include, in response to the converted customer data in the standardized format satisfying the predetermined criteria, sending a notification to a real estate management platform (step 912). The notification may include content based on the converted customer data in the standardized format (step 912).

In some embodiments, various elements in the steps of the method 900 may include elements discussed above in relation to FIGS. 1-8. Furthermore, various steps may include functionality discussed above in relation to FIGS. 1-8.

In one embodiment, the method 900 may further include receiving customer information for a customer associated with the account identifier, and customizing the predetermined criteria based on the customer information. The customer information may include a type of entity of the customer, an account balance of the customer, an income of the customer, or a revenue of the customer.

In one or more embodiments, converting the customer data to the standardized format based on one or more conversion rates (step 908) may include increasing, based on the customer data, a point balance associated with the account identifier. Automatically determining whether the converted customer data in the standardized format satisfies the first predetermined criteria (step 910) may include automatically determining that the point balance exceeds a predetermined point amount, automatically determining that the point balance exceeds a predetermined point amount within a predetermined amount of time, automatically determining that the point balance exceeds a predetermined point amount for a predetermined amount of time.

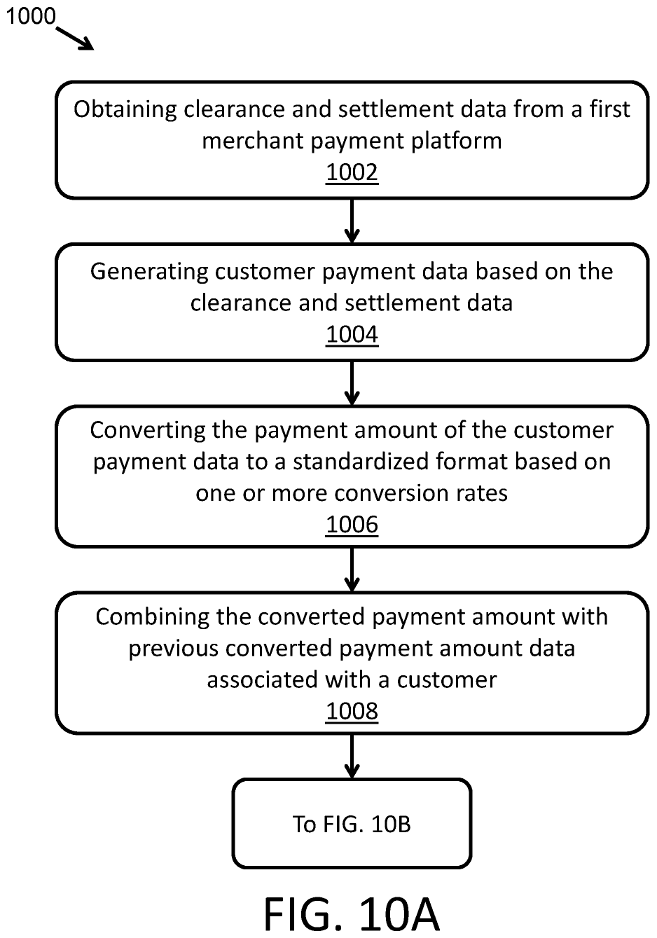

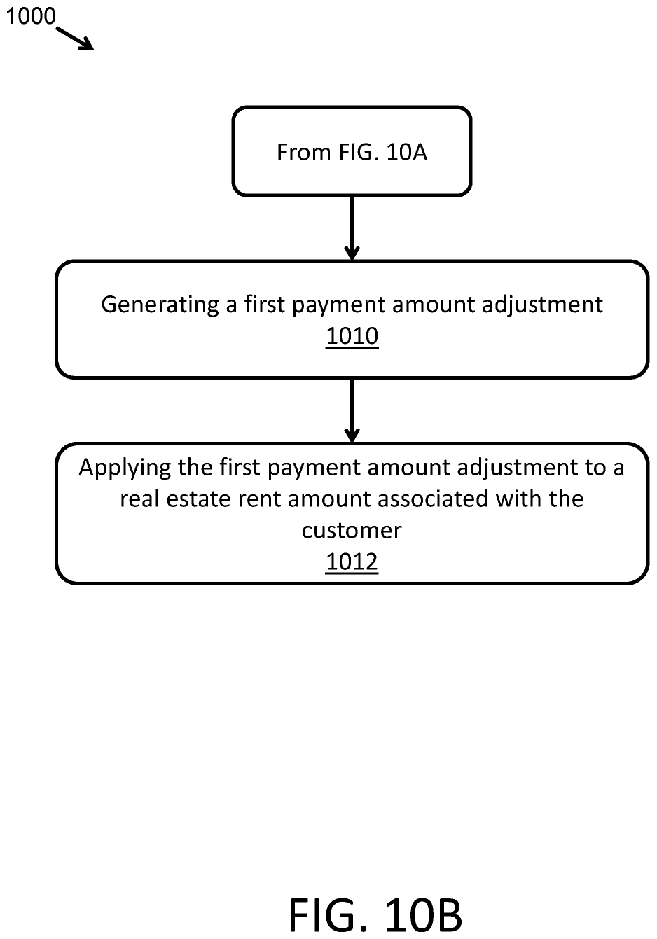

FIG. 10A and FIG. 10B depict one embodiment of a method 1000. The method 1000 may include a computer-implemented method for spend-based discount rent pricing for affordable real estate development. The method 1000 may include obtaining clearance and settlement data from a first merchant payment platform (step 1002). The clearance and settlement data may include data electronically captured from a customer payment card. The method 1000 may include generating customer payment data based on the clearance and settlement data (step 1004). The customer payment data may include a payment amount. The method 1000 may include, in response to the customer payment data satisfying one or more predetermined conditions, converting the payment amount of the customer payment data to a standardized format based on one or more conversion rates (step 1006). The method 1000 may include combining the converted payment amount with previous converted payment amount data associated with a customer (step 1008). The method 1000 may include, in response to the combined converted payment amount satisfying one or more predetermined criteria, generating a first payment amount adjustment (step 1010). The method 1000 may include applying the first payment amount adjustment to a real estate rent amount associated with the customer (step 1012).

In some embodiments, various elements in the steps of the method 1000 may include elements discussed above in relation to FIGS. 1-9. Furthermore, various steps may include functionality discussed above in relation to FIGS. 1-9.

In one embodiment, obtaining the clearance and settlement data (step 1002) may include obtaining the clearance and settlement data at a banking platform operated by a banking entity. The customer payment card may include a payment card issued by the banking entity. In some embodiments, converting the payment amount of the customer payment data to the standardized format (step 1006) may include generating an amount of points based on the payment amount. Combining the converted payment amount with the previous converted payment amount data associated with the customer (step 1008) may include increasing a point balance of the customer by the amount of points.

In one embodiment, applying the payment amount adjustment to the real estate rent amount (step 1012) may include reducing a rent amount. In some embodiments, the method 1000 may further include receiving customer purchase data from a second merchant payment platform. The customer purchase data may include a purchase amount. The method 1000 may further include, in response to the customer purchase data satisfying one or more predetermined conditions, converting the purchase amount of the customer purchase data to the standardized format based on one or more conversion rates. The method 1000 may further include combining the converted purchase amount with previous converted payment amount data associated with the customer. In some embodiments, the method 1000 may further include, in response to the combined converted purchase amount satisfying one or more predetermined criteria, generating a second payment amount adjustment. The method 1000 may further include applying the second payment amount adjustment to a real estate rent amount associated with the customer, including further reducing the rent amount.

In some embodiments, the banking platform 102 may be interchangeable with some other type of value-creating platform. A value-creating platform may include a platform that may generate revenue via fees, interest, partnership commissions, sales, or other activities. The value-creating platform may generate revenue that may subsidize the rent adjustments of the real estate management platform 110. For example, the value-creating platform may include an online marketplace platform. The online marketplace platform may allow customers to purchase goods or services on the platform. The online market place may generate revenue by charging customers a membership fee, receiving a commission on goods/services sold, charging merchants a fee to list goods or services on the online marketplace, or by other revenue-generating activities. The revenue of the online marketplace platform may subsidize the rent adjustments of the real estate management platform 110.

In some embodiments, the real estate management platform 110 may be interchangeable with some other type of product or service management platform. The product/service management platform may include a platform that manages the provision of goods or services to customers. The amount that a customer may pay in exchange for obtaining or using the goods or services may be adjusted based on the customer's activities on the value-creating platform (e.g., the banking platform 102 or some other value-creating platform). The product/service management platform may include a platform that manages the rental of a good such as real estate, vehicles, boats, storage space, event space, clothing, or other goods. The product/service management platform may include a platform that manages a customer's subscription to a service such as a video or audio streaming service, a software service, utilities, or other services. The product/service management platform may include a platform that manages how much a customer pays for certain types of goods or services such as groceries, medication, insurance, or other things.

While the making and using of various embodiments of the present disclosure are discussed in detail herein, it should be appreciated that the present disclosure provides many applicable inventive concepts that are embodied in a wide variety of specific contexts. The specific embodiments discussed herein are merely illustrative of specific ways to make and use the invention and do not delimit the scope of the invention. Those of ordinary skill in the art will recognize numerous equivalents to the specific apparatus and methods described herein. Such equivalents are considered to be within the scope of this invention and may be covered by the claims.

Furthermore, the described features, structures, or characteristics of the disclosure may be combined in any suitable manner in one or more embodiments. In the description contained herein, numerous specific details are provided, such as examples of programming, software, user selections, hardware, hardware circuits, hardware chips, or the like, to provide understanding of embodiments of the disclosure. One skilled in the relevant art will recognize, however, that the disclosure may be practiced without one or more of the specific details, or with other methods, components, materials, and so forth. In other instances, well-known structures, materials, or operations may not be shown or described in detail to avoid obscuring aspects of the disclosure.

These features and advantages of the embodiments will become more fully apparent from the description and appended claims, or may be learned by the practice of embodiments as set forth herein. As will be appreciated by one skilled in the art, aspects of the present disclosure may be embodied as an apparatus, system, method, computer program product, or the like. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present disclosure may take the form of a computer program product embodied in one or more computer-readable medium(s) having program code embodied thereon.

In some embodiments, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of program code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of program code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the program code may be stored or propagated on in one or more computer-readable medium(s).

In some embodiments, a module may include a smart contract hosted on a blockchain. The functionality of the smart contract may be executed by a node (or peer) of the blockchain network. One or more inputs to the smart contract may be read or detected from one or more transactions stored on or referenced by the blockchain. The smart contract may output data based on the execution of the smart contract as one or more transactions to the blockchain. A smart contract may implement one or more methods or algorithms described herein.

The computer program product may include a computer-readable storage medium (or media) having computer-readable program instructions thereon for causing a processor to carry out aspects of the present disclosure. The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium may include a portable computer diskette, a hard disk, a random access memory (“RAM”), a read-only memory (“ROM”), an erasable programmable read-only memory (“EPROM” or Flash memory), a static random access memory (“SRAM”), a hard disk drive (“HDD”), a solid state drive, a portable compact disc read-only memory (“CD-ROM”), a digital versatile disk (“DVD”), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network or a wireless network. The network may comprise copper transmission cables, optical transmission fibers, wireless transmission, routers, firewalls, switches, gateway computers or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, in order to perform aspects of the present disclosure.

Aspects of the present disclosure are described herein with reference to flowchart illustrations or block diagrams of methods, apparatuses, systems, algorithms, or computer program products according to embodiments of the disclosure. It will be understood that each block of the flowchart illustrations or block diagrams, and combinations of blocks in the flowchart illustrations or block diagrams, can be implemented by computer-readable program instructions.

These computer-readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart or block diagram block or blocks. These computer-readable program instructions may also be stored in a computer-readable storage medium that can direct a computer, a programmable data processing apparatus, or other devices to function in a particular manner, such that the computer-readable storage medium having instructions stored therein comprises an article of manufacture including instructions which implement aspects of the function/act specified in the flowchart or block diagram block or blocks.

The computer-readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart or block diagram block or blocks.

The schematic flow chart diagrams included herein are generally set forth as logical flow chart diagrams. As such, the depicted order and labeled steps are indicative of one embodiment of the presented method. Other steps and methods may be conceived that may be equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

The schematic flowchart diagrams or schematic block diagrams in the Figures illustrate the architecture, functionality, and operation of possible implementations of apparatuses, systems, methods and computer program products according to various embodiments of the present disclosure. In this regard, each block in the schematic flowchart diagrams or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams or flowchart diagrams, and combinations of blocks in the block diagrams or flowchart diagrams, can be implemented by special purpose hardware-based systems that perform the specified functions or acts, or combinations of special purpose hardware and program code.

Thus, although there have been described particular embodiments of the present invention of a new and useful SPEND-BASED DISCOUNT RENT PRICING SYSTEM AND METHODS FOR AFFORDABLE REAL ESTATE DEVELOPMENT, it is not intended that such references be construed as limitations upon the scope of this invention.

What is claimed is:

1. A computer-implemented system for spend-based discount rent pricing for affordable real estate development, the system comprising:
one or more databases configured to receive and store one or more customer accounts, wherein each customer account includes
an account identifier, and
customer data associated with the account identifier, wherein the customer data includes at least one of customer payment data, or customer purchase data;
one or more computer-readable storage media having executable instructions store thereon; and
one or more computer processors, wherein the one or more processors, in response to executing the executable instructions, are configured to
receive first customer data,
store the first customer data in the one or more databases, wherein the customer data associated with the account identifier includes the first customer data,
automatically determine whether the customer data satisfies a predetermined condition,
in response to the customer data satisfying the predetermined condition, convert the customer data to a standardized format based on one or more conversion rates,
automatically determine whether the converted customer data in the standardized format satisfies a predetermined criteria, and
in response to the converted customer data in the standardized format satisfying the predetermined criteria, send a notification to a real estate management platform, wherein the notification includes content based on the converted customer data in the standardized format.

2. The computer-implemented system of claim 1, wherein the customer payment data comprises clearance and settlement data.

3. The computer-implemented system of claim 1, wherein the customer payment data comprises at least one of:
a first customer identifier;
a payment amount; or
a first merchant identifier.

4. The computer-implemented system of claim 1, wherein the customer purchase data comprises at least one of:
a second customer identifier;
a purchase amount;
an identifier of a good or a service;
a category of a good or a service; or
a second merchant identifier.

5. The computer-implemented system of claim 1, wherein the predetermined condition comprises that the customer data includes one or more purchase amounts.

6. The computer-implemented system of claim 1, wherein the predetermined condition comprises that the customer data includes one or more purchase amounts associated with a third merchant identifier.

7. The computer-implemented system of claim 6, wherein:
the one or more databases are further configured to store one or more merchant identifiers; and
the third merchant identifier includes a merchant identifier of one or more merchant identifiers.

8. The computer-implemented system of claim 1, wherein the predetermined criteria comprises at least one of:
the converted customer data in the standardized format exceeds a predetermined amount;
the converted customer data in the standardized format exceeds a predetermined amount within a predetermined amount of time; or
the converted customer data in the standardized format exceeds a predetermined amount for a predetermined amount of time.

9. The computer-implemented system of claim 1, wherein a customer associated with the customer account comprises at least one of:
a natural person; or
a business entity.

10. A computer-implemented method for spend-based discount rent pricing for affordable real estate development, comprising:
receiving customer data;
storing the customer data in one or more databases, wherein the customer data is associated with an account identifier stored on the one or more databases;
automatically determining whether the customer data satisfies a predetermined condition;
in response to the customer data satisfying the predetermined condition, converting the customer data to a standardized format based on one or more conversion rates;
automatically determining whether the converted customer data in the standardized format satisfies a predetermined criteria; and
in response to the converted customer data in the standardized format satisfying the predetermined criteria, sending a notification to a real estate management platform, wherein the notification includes content based on the converted customer data in the standardized format.

11. The computer-implemented method of claim 10, further comprising:
receiving customer information for a customer associated with the account identifier; and
customizing the predetermined criteria based on the customer information.

12. The computer-implemented method of claim 11, wherein the customer information comprises at least one of:
a type of entity of the customer;
an account balance of the customer;
an income of the customer; or
a revenue of the customer.

13. The computer-implemented method of claim 10, wherein converting the customer data to the standardized format based on one or more conversion rates comprises increasing, based on the customer data, a point balance associated with the account identifier.

14. The computer-implemented method of claim 13, wherein automatically determining whether the converted customer data in the standardized format satisfies the first predetermined criteria comprises at least one of:
automatically determining that the point balance exceeds a predetermined point amount;
automatically determining that the point balance exceeds a predetermined point amount within a predetermined amount of time; or
automatically determining that the point balance exceeds a predetermined point amount for a predetermined amount of time.

15. A computer-implemented method for spend-based discount rent pricing for affordable real estate development, comprising:
obtaining clearance and settlement data from a first merchant payment platform, wherein the clearance and settlement data comprises data electronically captured from a customer payment card;
generating customer payment data based on the clearance and settlement data, wherein the customer payment data includes a payment amount;
in response to the customer payment data satisfying one or more predetermined conditions, converting the payment amount of the customer payment data to a standardized format based on one or more conversion rates;
combining the converted payment amount with previous converted payment amount data associated with a customer;
in response to the combined converted payment amount satisfying one or more predetermined criteria, generating a first payment amount adjustment; and
applying the first payment amount adjustment to a real estate rent amount associated with the customer.

16. The computer-implemented method of claim 15, wherein:
obtaining the clearance and settlement data comprises obtaining the clearance and settlement data at a banking platform operated by a banking entity; and
the customer payment card comprises a payment card issued by the banking entity.

17. The computer-implemented method of claim 15, wherein:
converting the payment amount of the customer payment data to the standardized format includes generating an amount of points based on the payment amount; and
combining the converted payment amount with the previous converted payment amount data associated with the customer includes increasing a point balance of the customer by the amount of points.

18. The computer-implemented method of claim 15, wherein applying the payment amount adjustment to the real estate rent amount comprises reducing a rent amount.

19. The computer-implemented method of claim 18, further comprising:
receiving customer purchase data from a second merchant payment platform, wherein the customer purchase data includes a purchase amount;
in response to the customer purchase data satisfying one or more predetermined conditions, converting the purchase amount of the customer purchase data to the standardized format based on one or more conversion rates; and
combining the converted purchase amount with previous converted payment amount data associated with the customer.

20. The computer-implemented method of claim 19, further comprising:
in response to the combined converted purchase amount satisfying one or more predetermined criteria, generating a second payment amount adjustment; and
applying the second payment amount adjustment to a real estate rent amount associated with the customer, including further reducing the rent amount.
